(19) United States
(12) Patent Application Publication
(10) Pub. No.: US 2015/0066535 A1
(43) Pub. Date: Mar. 5, 2015

(54) SYSTEM AND METHOD FOR REPORTING MULTIPLE MEDICAL PROCEDURES

(71) Applicant: George M. Dobrean, Kitchener (CA)

(72) Inventor: George M. Dobrean, Kitchener (CA)

(21) Appl. No.: 14/012,123

(22) Filed: Aug. 28, 2013

(51) Int. Cl. G06F 19/00

(52) U.S. Cl. CPC G06F 19/3487
USPC 705/3

(57) ABSTRACT

A system and method is provided for reporting a plurality of medical procedures. A first medical procedure and second medical procedure are defined as to-be-reported. A plurality of report sections for the first medical procedure and the second medical procedure are created. A first subset of the created report sections is associated with the first medical procedure. A second subset of the created report sections is associated with the second medical procedure, at least one report section of the second subset also being associated with the first subset. A request for undefining the first medical procedure as to-be-reported is received and in response to the request for undefining the first medical procedure, the first medical procedure is disassociated from each of the at least one report section that is associated with the first medical procedure and the second medical procedure.

### FIELD

Exemplary embodiments described herein relate to systems and methods in the medical field. More specifically, they relate to a system and method for creating medical report records for multiple medical procedures within one reporting task.

### INTRODUCTION

Medical reports, especially radiology reports, are an essential component of a patient's health record. They serve several purposes: medico-legal communication; a standard of comparison with other radiological procedures; a permanent record in the case of lost images; communication with other health professionals; a means of expediting the treatment; and a method to assist in formulating an accurate and precise clinical diagnosis.

The goal of any medical information technology system is to improve the quality of care. In this context, report completeness and consistency are generally desired. Medical reporting, especially in the radiology context, is a service used by other clinical specialties including general practice. Therefore medical and radiology reports are used by clinicians and general practitioners. Clinicians and general practitioners are interested in both efficient and effective diagnostic data gathering and diagnostic data analysis and statistics for patient care, research or administration.

### SUMMARY

The embodiments described herein provide in one aspect a method for reporting a plurality of medical procedures. The method includes defining a first medical procedure and a second medical procedure as to-be-reported, creating a plurality of report sections for the first medical procedure and the second medical procedure, associating a first subset of the created report sections with the first medical procedure, associating a second subset of the created report sections with the second medical procedure, at least one report section of the second subset also being associated with the first subset, receiving a request for undefining the first medical procedure as to-be-reported; and in response to the request for undefining the first medical procedure, disassociating the first medical procedure from each of the at least one report section that is associated with the first medical procedure and the second medical procedure.

The embodiments described herein provide in another aspect a system for reporting a plurality of medical procedures. The system includes a memory for storing a plurality of instructions, a data storage device, and a processor coupled to the memory. The processor is configured for defining a first medical procedure and second medical procedure as to-be-reported, creating a plurality of report sections for the first medical procedure and the second medical procedure, associating a first subset of the created report sections with the first medical procedure, associating a second subset of the created report sections with the second medical procedure, at least one report section of the second subset also be associated with the first subset, receiving a request for undefining the first medical procedure as to-be-reported, and in response to the request for undefining the first medical procedure, disassociating the first medical procedure from each of the at least one report section that is associated with the first medical procedure and the second medical procedure.

Further aspects and advantages of the embodiments described will appear from the following description taken together with the accompanying drawings.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the components of an exemplary embodiment of a system for generating medical reports using text macros;

FIG. 2 is a schematic diagram of an exemplary input screen for entering observations for a medical procedure;

FIG. 3 is a schematic diagram of an exemplary text macro;

FIG. 4 is a flowchart illustrating the general operational steps of an exemplary embodiment of the medical report generation system for completing a medical record;

FIG. 5 is a flowchart illustrating the general operational steps of an exemplary embodiment for retrieving text macros;

FIG. 6 is a flowchart illustrating the general operational steps of an exemplary embodiment for determining whether a selected text macro is compatible with a selected report structure.

FIG. 7 is a flowchart illustrating the general operational steps of an exemplary embodiment for updating a report section of a report structure.

FIG. 8 is a flowchart illustrating the general operational steps of an exemplary embodiment for completing a medical record;

FIG. 9 is a flowchart illustrating the general operational steps of an exemplary embodiment for selecting a normal report;

FIG. 10 is a flowchart illustrating the general operational steps of an exemplary embodiment for creating a text macro;

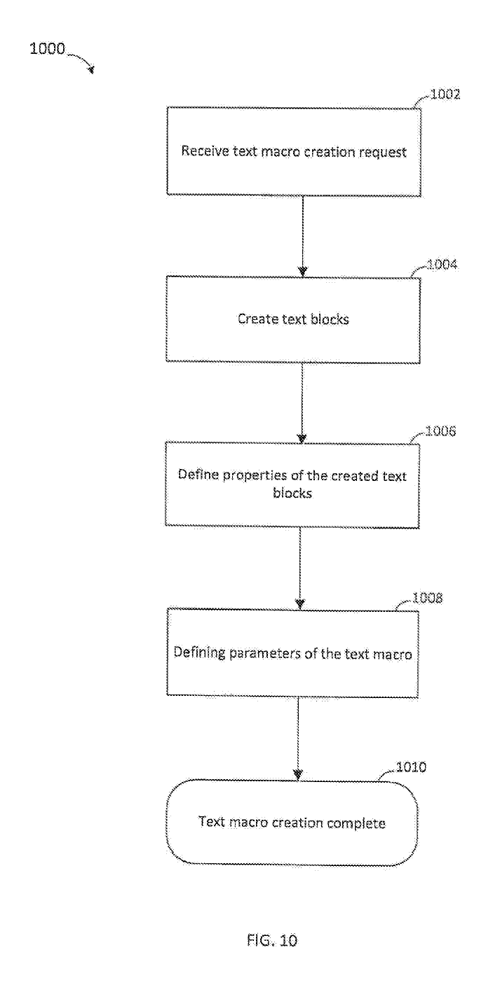

FIG. 11 illustrates an exemplary data structure for storing unreported medical procedures:

FIG. 12 illustrates an exemplary data structure for storing the procedure outputs of unreported medical procedures;

FIG. 13 is a flowchart illustrating the general operational steps of an exemplary embodiment of a method for multi-procedural reporting;

FIG. 14 is a schematic diagram illustrating an exemplary user interface during multi-procedural reporting;

FIG. 15 illustrates an exemplary data structure for tracking medical procedures that have been defined as to-be-reported;

FIG. 16 illustrates exemplary report structures retrieved for two medical procedures defined as to-be-reported;

FIG. 17 is a flowchart illustrating the operational steps for carrying out a portion of multi-procedural reporting;

FIG. 18 is a flowchart illustrating the operational steps for displaying the contents of a created report section;

FIG. 19 is a schematic diagram illustrating validated medical records;

FIG. 20 illustrates an exemplary data structure for tracking medical procedures during a reporting task;

FIG. 21 illustrates an exemplary data structure for tracking medical procedures during a reporting task; and

FIG. 22 illustrates exemplary report structures selected for additional medical procedures.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, cellular telephone, smartphone, or tablet device. Program code is applied to input data to perform the functions described herein and generate output information. The output information is applied to one or more output devices in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloadings, magnetic and electronic storage media, digital and analog signals, and the like. The computer-usable instructions may also be in various forms including compiled and non-compiled code.

“Medical procedure” herein refers to one medical action performed on a patient using a medical modality. The action generates procedure outputs, which may be measurements made by the modality on the patient.

“Medical order” herein refers to one or more medical procedures that are performed to determine condition of a patient. Typically, the procedures that are performed are in regard to one condition, or a set of related conditions, for one patient.

“Reporting task” herein refers to a step in the process for creating a medical record wherein the procedure outputs of one or more medical procedures are made available to a medical professional and wherein the medical professional provides observations relating to the procedure outputs. A “reporting task” may be session based in which the medical procedures are made available during the session.

“Medical record” herein refers to observations that have been “signed-off” or “validated” by the medical professional. The medical record becomes part of the overall medical record for the patient and can be reviewed by other medical professionals to obtain a patient's medical history. Once a medical record is validated, its entries can no longer be modified in any way.

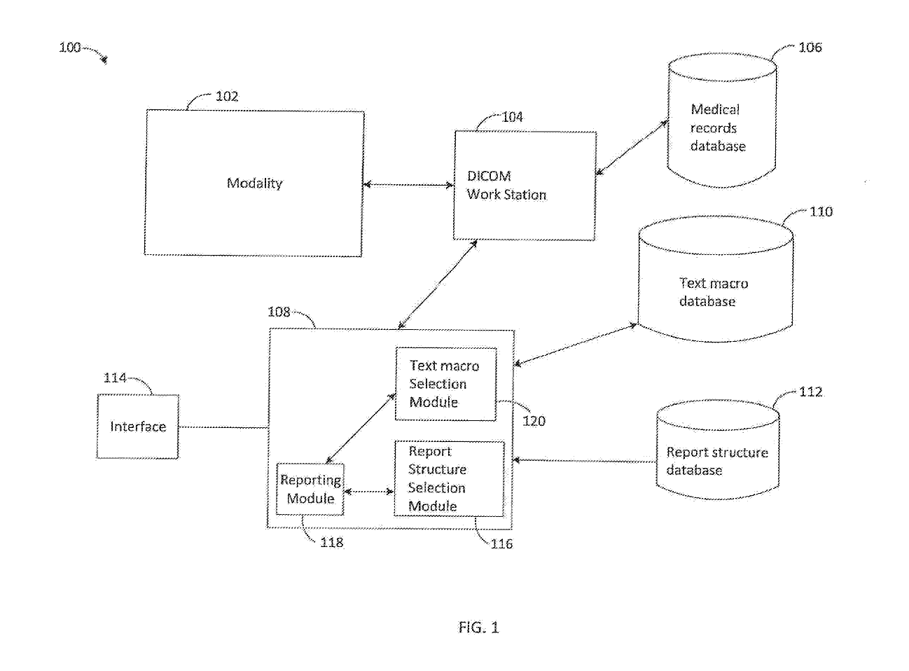

Reference is now made to FIG. 1, which illustrates elements of an exemplary embodiment of a medical report generation system 100. A modality 102, which may be any type of suitable medical device, is used for carrying out a medical procedure. Such a device may be for example Computed Radiography (CR), Computed Tomography (CT), Magnetic Resonance Imaging (MRI), Ultrasound (US), Positron Emission Tomography (PET), Digital Radiography (DX), Mammography (MG), X-Ray Angiography (XA), Nuclear Medicine (NM), or other device.

A DICOM workstation 104 may be connected to the modality 102. For example, it may be used to control the modality 102 for carrying out a medical procedure. DICOM workstation 104 may be further connected to a medical records database 106 for storing and retrieving medical records. For example, initial results, such as medical images, obtained from carrying out a medical procedure using modality 102 may be stored in the medical records database 106.

The medical report generation system 100 may be connected with the DICOM workstation 104 to send data thereto and receive data therefrom. Alternatively, medical report generation system 100 may be directly connected with the medical records database 106 to send data thereto and receive data therefrom.

The medical report generation system 100 may also be connected to a text macro database 110, which stores a plurality of text macros that are available to be used in sectional medical procedure reporting.

The medical report generation system 100 may also be connected to a report structure database 112, which stores a plurality of report structures to be used in sectional medical procedure reporting.

According to some exemplary embodiments, the medical report generation system 100 may have its own text macro database stored locally comprising a first set of available text macros. In addition, the medical report generation system 100 may be connected to an externally stored text macro database, such as text macro database 110, comprising a second set of available text macros.

Similarly, according to some exemplary embodiments, the medical report generation system 100 may have its own report structure database stored locally comprising a first set of report structures. In addition, the medical report generation system 100 may be connected to an externally stored report structure database, such as report structure database 112, comprising a second set of report structures.

A user interface 114 is provided to allow a user carrying out sectional reporting of a completed medical procedure to interact with the medical report generation system 100. A user may be a medical professional such as a doctor, dentist, physician, etc. The user interface 114 may include a display and input device. The input device may be any device that allows the user to send commands to the medical report generation system 100. The input device may be, but not limited to, a keyboard, a stylus, a mouse, a dictation device, a voice recognition system, or a motion detection sensor.

As discussed in more detail elsewhere, it should be understood that the medical report generation system 100 may be implemented in hardware or software or a combination of both. Specifically, the modules of medical report generation system 100 are preferably implemented in computer programs executing on programmable computers, each comprising at least one processor, a data storage system, at least one input device and at least one output device. Without limitation, the programmable computers may be a mainframe computer, server, personal computer, laptop, personal data assistant, cellular telephone, smartphone or tablet device. In an exemplary implementation, the medical report generation system 100 is implemented in software and installed on the hard drive of any suitable client workstation, such as client workstation 108, such that the client workstation 108 interoperates with the DICOM workstation 104 in a client-server configuration.

During reporting of a completed medical procedure (e.g. a radiology exam) for a given patient, the user will first view and analyze the outputs of the medical procedure. For example, outputs may be the medical images, performed procedure specific questionnaires, dose information or other type of procedure related attachments (e.g. voice notes, written comments) coming from Computed Radiography (CR), Computed Tomography (CT), Magnetic Resonance Imaging (MRI), Ultrasound (US), Positron Emission Tomography (PET), Digital Radiography (DX), Mammography (MG), X-Ray Angiography (XA), Nuclear Medicine (NM), and other modalities. The user will then record his or her observations of the medical procedure. For example, in field of radiology, it is typical for the user to analyze medical images of a radiology exam and to record her observations of the medical images. The outputs of the medical procedure and the user's observations are then recorded within a medical record. A medical report can be generated from the outputs and observations contained in the medical record. In other cases, the outputs and observations are stored within a medical record, for example in database. More medical reports can be generated at later time from the stored medical records if desired.

As medical reports for the medical record will be reviewed by other users later, it is desirable for the medical record to be organized and easy to read. The ease of use of the medical record depends on how the user initially enters observations for the medical procedure performed.

Sectional reporting is a method of reporting which allows a user to enter observations on the outputs of a medical procedure in an organized manner. The user separately enters observations for various aspects of the medical procedure. For example in radiology, a radiology procedure will include sections such as radiologist findings, reasons for the procedure, clinical indications, comparison studies, follow-up, image measurements, key images, procedure details, impressions, remarks, conclusions, recommendations and addendum. The separately entered observations are then separately maintained as report sections, which can then be used to create a medical record and/or generate a medical report.

An advantage of sectional reporting is that separately entered observations that are maintained as separate report sections can also be separately stored. This further allows for separate retrieval of the stored report sections. Unlike block form reporting where all the observations are entered as one continuous and contiguous data block that is difficult to parse, separate storage of the report sections allows for quick retrieval of only the report sections of interest. This allows for targeted analysis of medical records of completed medical procedures. In other cases, retrieval of separate report sections allows for data mining and analysis across numerous medical procedures. For example, it is possible to compare observed conclusions of a same type of medical procedure for many medical procedures of that type. Alternatively, it is possible to compare observed conclusions of several different types of medical procedures.

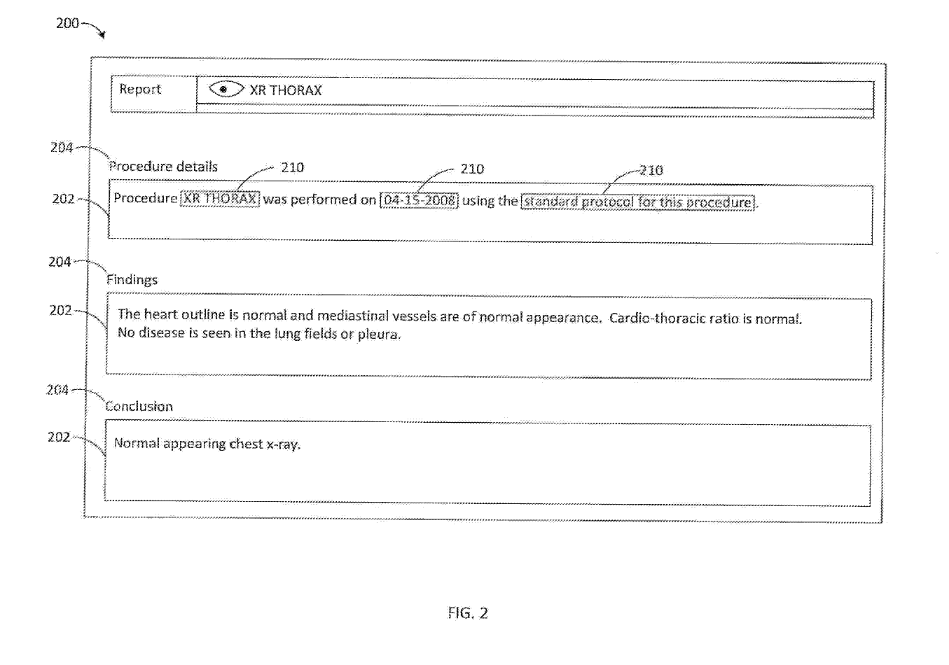

Referring to FIG. 2, therein illustrated is a schematic diagram of an exemplary input screen 200 displayed to a user on user interface 114 for entering observations for a medical procedure. For example, input screen 200 may have one or more observation entry boxes 202 for receiving entries of the user's observations. Each observation entry box 202 corresponds to a report section to be completed and maintained in a medical record. The observation entry boxes 202 may be associated with a type of report section to be maintained and may have an identifier 204 identifying the type of the report section.

For example, input screen 200 has identifiers 204 for report sections of the types “procedure details”, “findings” and “conclusions”. It will be understood that other types of report sections may be shown for completing the sectional reporting. The types of report sections shown on user interface 114 are based on a report structure selected for reporting the medical procedure. The report structure indicates one or more types of report section that are required to be entered for a complete medical record to be created. The report structure may further indicate types of report sections that are complementary in that they are not required for completing the reporting of the completed medical procedure.

The report structure that is selected depends on the properties of the completed medical procedure to be reported. Properties of the medical procedure should be understood as any properties associated with the medical procedure, including, but not limited to, the type of medical procedure, characteristics of the patient, the type of equipment used, and the medical worker who carried out the procedure.

For example, a specific type of medical procedure, such as a mammography, will require specific types of user observations and therefore specific types of report sections need to be completed. For example in the case of mammography, these report section types may be BI-RADS assessment or BI-RADS score. As a further example, a patient above or below a certain age or being of a specific ethnic background may require specific report section types to be entered. For example, in pediatrics, useful sections type may be ones for bone age or development milestones. This information may further influence the report structure that is selected for reporting the completed medical procedure.

In some exemplary embodiments, the medical report generation system 100 may have a report structure selection module 116 that accesses report structures database 112 in order to retrieve the report structure that is suitable for the medical procedure to be reported.

In some exemplary embodiments, multiple report structures may correspond to the medical record creation request. For example, for a medical procedure, it may be possible to create a short form record requiring only a few report section types to be completed, or it may be possible to create a long form record for completing a higher number of report sections of different types. In these embodiments, the report structure selection module 116 may present each of the corresponding report structures to the user via the user interface 114 to allow the user to select the most appropriate structure. Alternatively, the report structure selection module 116 may automatically select the report structure that is most relevant, or commonly used.

After retrieving a report structure, a reporting module 118 of the medical report generation system creates report sections for receiving observation entries. For example, report sections may be created and temporarily maintained in the system memory of the medical report generation system 100 during reporting. Report sections may be created for both required and non-required types of report section indicated by the selected report structure. For each created report section, an observation entry box 202 along with the identifier 204 identifying the type of report section may be displayed on the user interface 114. Created report sections may be populated by receiving entries made by the reporting user using the input device of the user interface 114. Populating of the created report sections may also be done by insertion of text blocks of text macros. Once all the types of report section indicated by the report structure as being required are populated and the reporting user has indicated that reporting is complete, the populated report sections may be stored within a medical record and/or used to generate a medical report.

In some exemplary embodiments, after displaying the observation entry boxes 202 that correspond to the types of report sections indicated by the report structure, the reporting user may further manually modify which types of report sections are to be completed by selectively adding or removing types of report sections. This allows the user to manually customize the medical record that will be created. For example, this customization can allow a user to add an additional type of report section that is not part of the selected report structure, but which may be important for the given medical procedure or patient.

Storage of report sections after completion of the reporting of the medical procedure may occur locally on the medical report generation system 100, for example, when a medical report is to be immediately created from the observations entered by the user. Alternatively, the entered observations are stored within medical record in the medical records database 106 in an organized section reporting format to allow easy retrieval of the record or of individually stored report sections for generating a medical report at a later time.

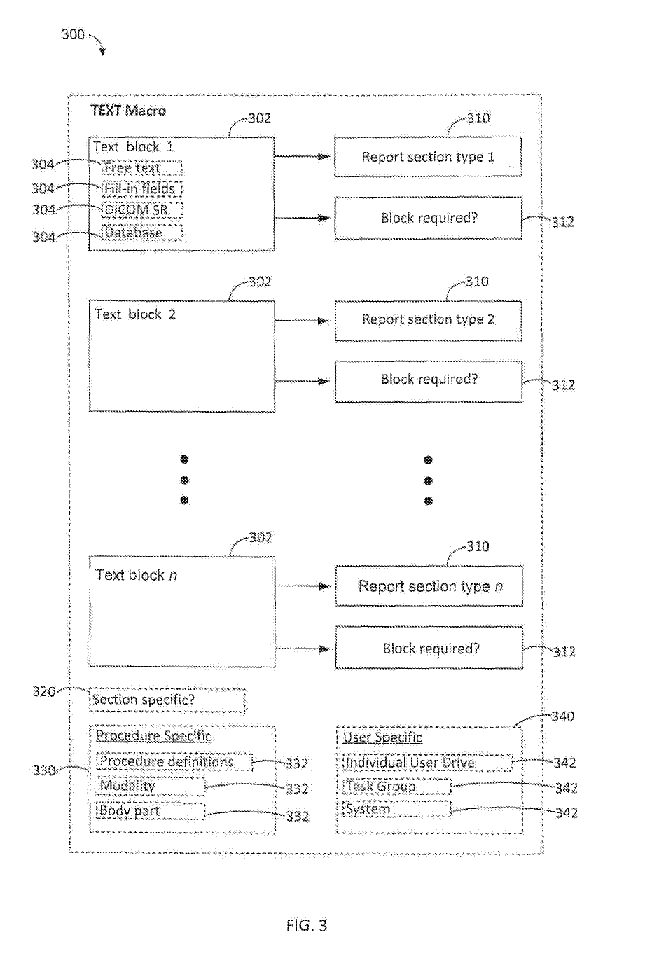

Referring now to FIG. 3, therein illustrated is a schematic diagram of an exemplary text macro 300 according to various embodiments that may be used to populate report sections of a selected report structure. A text macro 300 is a tool available to the user for entering observations for completing sectional reporting of a medical procedure.

Each text macro 300 comprises at least one text block 302, which may be identified by a text block number, for example 1 to n.

Each text block 302 has stored observation entry fields 304. The observation entry fields 304 are specific types of entries used to populate created report sections. Observation entry fields 304 may be of one or more types, such as plain text, fill-in fields, DICOM SR, and database field.

Plain text can be simply a string of text, such as “normal appearing chest x-ray”.

Fill-in field can indicate an observation entry sub-field within the observation entry box that must be completed by the user in order to complete the sectional reporting of the medical procedure. In some embodiments, a fill-in field may appear as a blank text box within an observation entry box 202. The user may then manually make an entry for the blank text box, which will then be saved within the created report section associated to the observation entry box 202. The fill-in field may contain a label to assist the user in knowing what type of entry to make, for example “right kidney length”.

Referring back to FIG. 2, for example, observation entry box 202 associated with the identifier 204 “Procedure details” contains three fill-in fields 210 that have been filled with the entries “XR THORAX”, “04-15-2008” and “standard protocol for this procedure”. Advantageously, the user interface 114 may be configured such that the user may quickly navigate through the fill-in fields of various observation entry boxes 202. For example, the user may scroll through the fill-in fields using a keyboard shortcut or using a voice command. Where the observation entry fields 304 of the text blocks 302 of the selected text macro 300 are already preconfigured with appropriate plain text and fill-in fields, the user need only navigate the fill-in fields and complete these fill-in fields in order to complete reporting of the medical report.

According to some exemplary embodiments, some of the fill-in fields may be set to be mandatory, in that, sectional reporting of the medical report may be completed only if all of the mandatory fill-in fields have received an appropriate entry.

According to some exemplary embodiments, some of the fill-in fields may be auto-filled based on certain preset rules. For example, a fill-in field of a text block may be linked to a set of entries that are determined based on some properties of the completed medical procedure being reported, such as patient age and gender. A different entry may be used to auto-fill the fill-in field based on different combinations of the properties. For example, when a text macro that has a fill-in field that is based on age and gender is used to populate a report section, two different entries may be entered into the fill-in field. If a female of childbearing age is the subject, the entry “Prior to the chest x-ray, the procedure was explained to the patient. The patient was also asked about pregnancy status and responded she was not pregnant.” may be entered. If a male patient was the subject, the entry “Prior to the chest x-ray, the procedure was explained to the patient” is entered instead without reference to pregnancy.

According to some exemplary embodiments, the possible values that may be entered into a fill-in field may be limited to a predefined set of values. For example, if a fill-in field is used to define a body part, the possible values may be limited to “left” or “right”. For example, fill-in field with a limited set of values may be presented as a drop-down menu within the observation entry box 202 on the user interface 114.

Referring back to FIG. 3, observation entry field 304 DICOM SR objects can indicate the content or results obtained for the medical procedure by the modality used to carry it out. For example, such objects may be measurement data or calculation results.

Database fields can indicate fields that are automatically populated based on data contained in various databases. For example database fields may be linked to any one of the following:
accession number (order level);
accession number;
study date (date on which the exam was performed);
order creation date;
number of images;
number of series;
patient: display name, first name, last name, middle name, prefix (Mr., Ms., Mrs.), age (days, weeks, months, years), sex (male/female), date of birth, ID;
technologist display name;
performing physician: display name, first name, last name, middle name;
ordering physician: display name, first name, last name, middle name, phone, title, address;
ordering department name;
ordering facility name;
report author: display name, first name, last name, middle name, title;
ordered procedure: code, name;
ordered procedure—body part;
ordered procedure—modality type;
report creation date and time;
reason for study;
study UID;
performed procedure step: code, comment, description, start time, end time, modality DICOM code, modality DICOM name;
exam room;
admission number.

According to some exemplary embodiments, the database field may be configured similarly to a fill-in field. For example, after the data from the database is retrieved and entered into the field, the reporting user can edit the entry. The user may also navigate across the various database fields of one or more observation entry boxes 202, for example using a voice command or keyboard shortcut.

According to some exemplary embodiments, if a database field is linked to a data entry in a database that is empty, the database field displayed in the observation entry box 202 of user interface 114 should also be left empty. Subsequently, when the report sections are saved within a medical record, the location of the database field within the corresponding report section is also left empty.

According to some exemplary embodiments, when a data entry in the database is updated, the database field linked to that data is also updated. However, when the user validates the medical record or medical report, for example, by signing off on the created medical record or report after completing sectional reporting, the database fields are frozen and no longer updated when the data in the database is updated. It is only by undoing the signing-off that the database fields can be automatically updated again.

According to some exemplary embodiments, when a database field is populated by the data of the database, this entry can be edited. However when the user subsequently edits the database field, the data from the database that is entered in the database field is changed to plain text and is no longer updated automatically.

According to some exemplary embodiments, each text block 302 may further have an associated report section type parameter 310, which indicates the type of report section for which the text block 302 is to be entered. For example, where a report section type parameter 310 is specified for a text block 302, the observation entry fields 304 of the text block 302 may only be used to populate a report section of the same type.

According to some exemplary embodiments, each text block 302 may further have an associated block required parameter 312, which indicates whether the text block 302 is required for completing the sectional reporting of the medical procedure. For example, no report can be signed off if the section block designed to indicate the availability of prior comparison studies is filled in, as this information is critical and mandatory, but a report can be signed off even though the section block designed to indicate the recommendation is left empty, as this information is always necessary for all procedures.

Text macro 300 further comprises text macro parameters which are used to determine the type of the text macro and, in some cases for determining the relevancy of the text macro 300 with respect to a medical procedure to be reported. For example, text macro 300 may comprise a “section specific” parameter 320, which indicates whether or not the text macro 302 is suitable for only populating a single report section. As described later, section-specific text macro may be used to “automatically” populate created report sections of a particular type without the user having to make text macro selection.

In some cases, the text macro 300 may be a free-text text macro. In such cases the text macro 300 only has one text block 302, which is not associated with any type of report section. Therefore, observation entry fields 304 of the text block 302 of the free-text text macro 300 may be used to populate a report section of any type. For example, often used text strings for reporting a medical procedure may be stored as a non-specific text macro 300, such as, “Patient's condition appears to be normal”.

For example, text macro 300 may comprise a “procedure specific” parameter set 330 having a plurality of sub-parameters 332. Procedure specific parameter set 330 indicates the type of medical procedure for which the text macro is relevant. For example, text-macro parameter set 330 can have sub-parameters 332 of “procedure definition=‘radiology’”; “modality=‘CT-scan’” and “body part=‘abdomen’” to indicate that the text macro is relevant for radiology, for CT-scans and for ‘abdomens’.

For example, text macro 300 may comprise a “user specific” parameter set 340 having a plurality of sub-parameters 342. User-specific parameter set 340 indicates the users or user groups for which the text macro is relevant. For example, text-macro parameter set 340 can have sub-parameters of “individual user=‘Dr. XYZ’”, “task group=‘radiology’” and “system=‘hospital ABC’” to indicate that the text macro is most relevant for Dr. XYZ, less particularly for radiology task group and even less so for hospital ABC.

Available text macros 300 are stored within the text macro database 110 which may be accessed by a text macro selection module 120 of the medical report generation system 110.

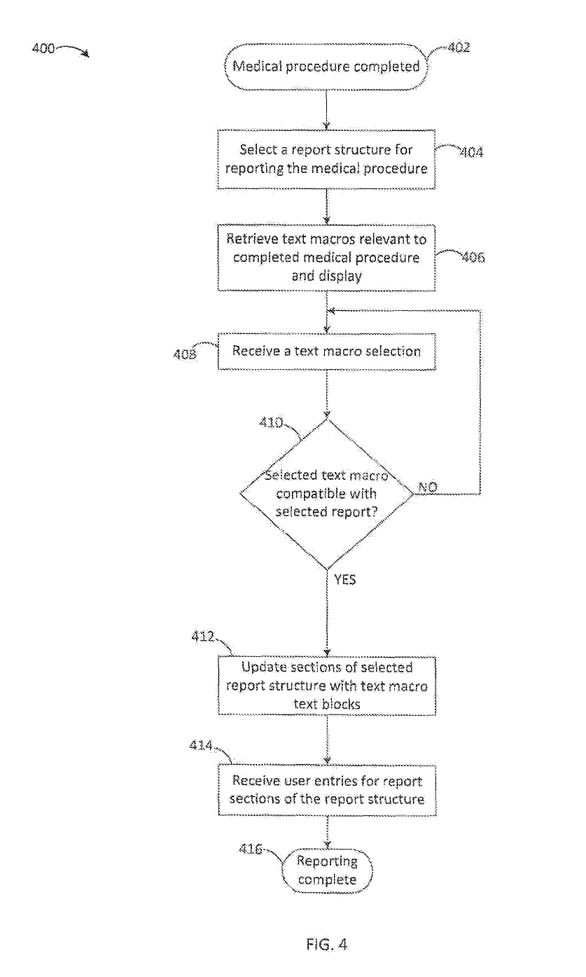

Referring to FIG. 4, therein illustrated is a schematic diagram of the steps 400 of a method for completing a medical record according to some exemplary embodiments. FIG. 4 illustrates example embodiments where the user makes a text macro selection in order to aid in the sectional reporting. However it should be understood that the exemplary embodiments described should not be limited to where the user must make a text macro selection. That is, it should be understood that according to some embodiments, a user can always complete sectional reporting of a medical procedure without making a text macro selection and instead complete the reporting by manually entering observations into the observation entry boxes 202. Such alternatives are intended to be covered by the current description.

At 402, a medical procedure performed on modality 102 is completed. For example, one or more medical images and one or more measurements taken during the medical procedure may be stored within a medical record in medical records database 106. A request for reporting the completed medical record and creating a medical record is received at the medical report generation system 100. The request will indicate at least some properties of the medical procedure, such as the type, date, time, modality and/or body part.

At step 404, a report structure that corresponds to the completed medical procedure indicated in the received medical record creation request is selected. Selection of the report structure may be performed by the report structure selection module 116 according to exemplary methods described above.

At step 406, text macros 300 relevant to the completed medical procedure are retrieved and titles of the text macros may be displayed on the user interface 114 to the user entering observations to complete the sectional reporting of the medical procedure. For example, retrieval of relevant text macros 300 may be performed by text selection module 120. For example, retrieval of relevant text macros 300 may be performed based on the text macro parameters and sub-parameters of the available text macros 300.

At step 408 a selection of a text macro 300 is received. For example, after the retrieved relevant text macros 300 are displayed as a list by their respective titles, the user can make a selection of a desired text macro by selecting, such as hovering over with the mouse over the displayed text macro title, highlighting the displayed text macro title, clicking the displayed text macro title or providing a voice command corresponding to the text macro 300.

At step 410, a determination is made of whether the text macro 300 selected at step 408 is compatible with the report structure selected at step 404. It will be appreciated that the selected report structure will indicate one or more types of report section that need to be completed and one or more complementary types of report sections. Likewise, the selected text macro 300 may also have one or more text blocks 302 that are required and that are associated with specific report section types 310. There may be an incompatibility between the selected report structure and the selected text macro if the required report section types 310 of the text macro 300 are not found within the set of types of report sections indicated by the report structure, and vice versa. In particular, there is an incompatibility where particular types indicated in the report section type parameters 310 associated with text blocks 302 of the selected text macro 300 are not found in the set indicated by selected report structure.

According to some embodiments, it may be determined that the selected text macro 300 is compatible with the selected report structure if all the types indicated in the report section type parameters 310 associated with the required text blocks 302 of the selected text macro 300 is a subset of only the required report section types indicated by the selected report structure. A text block 302 is required if its associated block required parameter 312 is set to “required”. Alternatively, it may be determined that the selected text macro is compatible with the selected report structure if all the types indicated in report section type parameters 310 associated with the required text blocks 302 of the selected text macro 300 is a subset of all the types of report sections indicated by the selected report structure, including both required report section types and complementary report section types.

If it is determined at 410 that the selected text macro 300 is not compatible with the selected report structure, the method may return to 408 to receive another text macro selection. For example, a message indicating that the selected text macro 300 is incompatible may be displayed on the user interface 114. Alternative text macros 300 may also be suggested on the user interface 114, such that the user can make another text macro selection and such that the method can return to 410 to further determine if the newly selected text macro is compatible with the selected report structure.

If it is determined at 410 that the selected text macro is compatible with the selected report structure, the method may continue to 412. At step 412, report sections created for the selected report structure are populated with the observation entry fields 304 of the text blocks 302 of the selected text macro 300.

For example, if the selected text macro 300 is free-text, then observation entry fields 304 of the one text block 302 of the selected text macro 300 may be inserted into the observation entry box 202 that is currently selected by the user on the user interface 114.

For example, if the selected text macro 300 is not free-text, the observation entry fields 304 of the text blocks 302, each being associated with report section types 310, are used to populate the created report sections having the same types.

At 414, entries that are made manually by the user are received. For example, a user may highlight an observation entry box 202 on the user interface 114, and make an entry or modification of the entry already made. For example, where an observation entry box 202 has not been inserted by an observation entry field 304 of a text block 302 of the selected text macro 300, the user may manually make an entry. Where the observation entry box 202 has been inserted with observation entry fields 304 of a text block 302 of the selected text macro 300 the user may modify that entry. Entry or modification may be performed by the user using any suitable input device of the user interface 114.

At 416, the sectional reporting of the medical procedure is completed and the temporarily created report sections may be stored as separate report sections within a medical record. For example, each report section may be stored to be associated with the report section type of the report section.

According to some exemplary embodiments, prior to completing the sectional reporting, a verification is made, for example by the reporting module 120, that all the report sections having the types indicated as being required by the selected report structure have been populated. According to some exemplary embodiments, a verification may also be made that the mandatory fill-in fields of observation entry field 304 of the text block 302 have been properly completed.

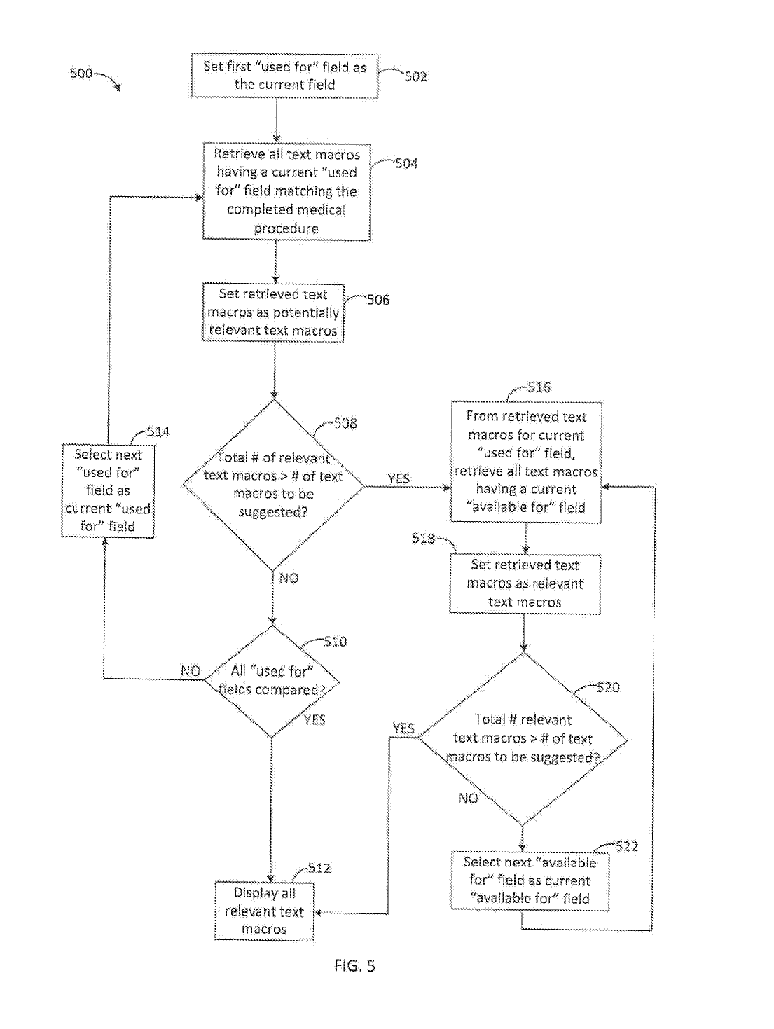

Referring now to FIG. 5, therein illustrated is a schematic diagram of a method 500 according to some exemplary embodiments for determining and retrieving text macros 300 that are relevant to the completed medical procedure to be reported.

At 502, a first procedure-specific property of the completed medical procedure that is to be reported is set as the current procedure-specific property. For example, where it is determined that the procedure definition is the most relevant property, procedure definition is set as the current procedure-specific property. For example, if the medical procedure to be reported has a procedure definition that is ‘radiology’, ‘radiology’ is set as the current procedure-specific property. Procedure specific property may also be understood as “used for” parameter of text macros 300 because it is used to determine whether a text macro 300 can be “used for” a specific type of medical procedure.

At 504, a search is made through the text macro database 110. The available text macros 300 stored in the text macro database 110 are checked to find all the text macros 300 of the available text macros 300 that have a procedure-specific parameter 332 that matches the current procedure-specific property. For example, if the current procedure-specific property is ‘radiology’, all text macros having the ‘radiology’ procedure definition sub-parameter 332 is retrieved at 504.

At 506, the text macros 300 retrieved at step 504 are set as potentially relevant text macros.

At 508, the total of the number of text macros 300 that are already identified as relevant and of those that are potentially relevant are compared with a predetermined number of relevant text macros 300 to be suggested. For example, it may be desired to only suggest a limited number of relevant text macros 300. Suggesting too many text macros 300 may overwhelm the user. Also, there may also not be enough space on the user interface 114 to display all the retrieved text macros.

If it is determined that the total number of text macros 300 that are relevant or potentially relevant does not exceed the predetermined number of relevant text macros 300 to be suggested, at 510 it is determined whether other procedure-specific properties of the medical procedure are available for finding more relevant text macros 300. If no more procedure-specific properties remain, then all text macros identified as relevant are suggested to the user at step 512, for example, by displaying them on the user interface 114.

If more procedure-specific properties remain, at step 514, the potentially relevant text macros retrieved at 504 are set as relevant text macros. Then the next most relevant procedure specific property, such as ‘modality’, may be selected as the current procedure specific property and the method returns to 504 to retrieve all text macros 300 having a sub-parameter 332 matching the newly set current procedure-specific property. It will be appreciated that text macros 300 having a sub-parameter matching procedure properties that are less specific to the completed medical procedure are also less relevant, and may be ordered after text macros 300 that have already been determined as being relevant.

Returning to step 508, if the total number of relevant text macros and potentially relevant text macros exceeds the number of relevant text macros 300 to be suggested, a further determination is made of relevancy of text macros from the text macros 300 identified as being potentially relevant based on another set of text macro sub-parameters, such as user-specific sub-parameters 342. Determination based on a second set of text macros sub-parameters is made to find which of the potentially relevant text macros are most relevant.

At 516, a second set of text macro sub-parameters is selected for the further determination of relevancy. The most relevant sub-parameter of the second set is set as the current sub-parameter. For example, where the second set of text macro sub-parameter is user-specific parameters, the current sub-parameter may be first set to ‘individual user’. User-specific parameters may also be understood as “available for” parameter of text macros because it is used to determine which users the text macro 300 can be made “available for.” From the potentially relevant text macros determined at step 506, all text macros 300 having a user-specific sub-parameter 332 matching the current user-specific property are retrieved at step 516.

At 518, all text macros retrieved at 516 is set as relevant text macros in addition to text macros previously identified as relevant text macros.

At 520, if the total number of relevant text macros after the retrieval at 518 is greater the number of text macros to be suggested, the relevant text macros are displayed at 512. For example, a number of most relevant text macros 300 equal to the number to be suggested may be displayed.

If the total number of relevant text macros does not exceed the number of text macros to be suggested, then at 522, the next most relevant sub-parameter of the second set of sub-parameters is selected as the current sub-parameter and at step 516 a further search is to identify from the potentially relevant text macros determined at step 506 all text macros 300 having a user-specific sub-parameter 332 matching the current user-specific property. Further searches according to the sub-parameter are made until the total number of relevant text macros is equal to or exceeds the number of text macros to be suggested, at which point the relevant text macros 300 are displayed at 512.

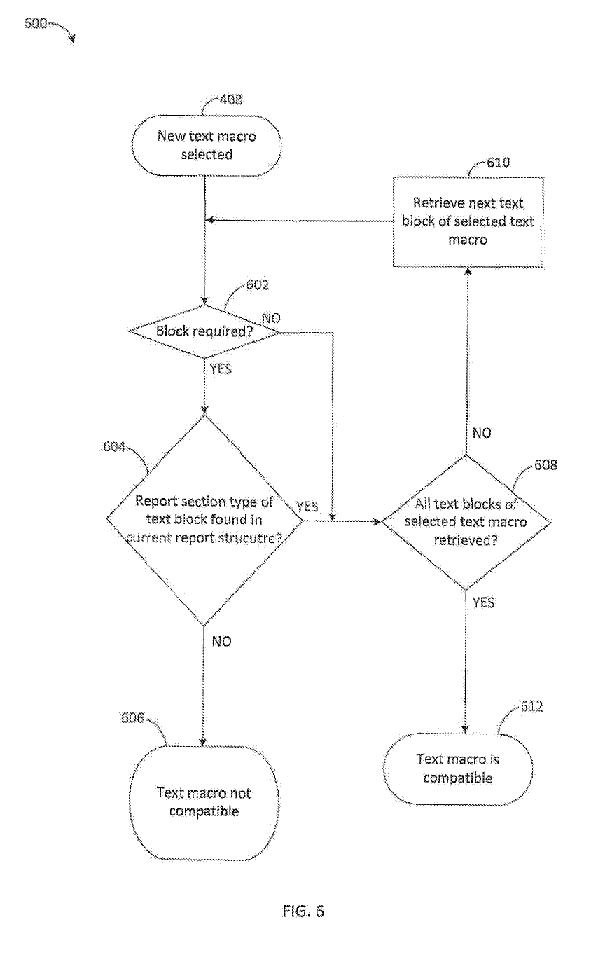

Referring now to FIG. 6, therein Illustrated is a schematic diagram of a method 600 according to some exemplary embodiments for determining whether the selected text macro 300 is compatible with the selected report structure. For example, various steps of the method 600 may be performed as part of step 410 for determining whether the selected text macro 300 is compatible. For example, steps of method 600 may be performed by the text macro selection module 120 of the client workstation 108.

For example, after a text macro selection is received at step 408, it is determined at 602 whether a first text block 302 of the selected text macro 300 is required. For example, this may be done by verifying the block required parameter 310 of the text block 302. If it is determined at step 602 that the text block 302 is required, at 604, it is further identified whether a report section of the same type is indicated by the selected report structure. This determination may be made by comparing the report section type parameter 310 of the text block 302 against the types of report section indicated by the selected report structure.

If it is determined at 604 that a report section of the same type as the report section type parameter 310 of the text block 302 is not indicated by the selected report structure, the selected report structure is determined at 606 to be incompatible with the selected text macro 300.

If it is determined at 604 that a report section of the same type as the report section type parameter 310 of the text block 302 is indicated by the selected report structure, the method 600 proceeds to 608 to determine if all the text blocks 302 of the selected text macro have been verified.

If it is determined at step 602 that the text block 302 is not required or if it is determined at step 604 that a report section of the same type as the report section type parameter 310 of the text block 302 is Indicated by the selected report structure, it is further determined at step 608 whether all the text blocks 302 of the selected text macro 300 have been verified. If not all the text macros have been verified, the next text block 302 of the selected text macro 300 is retrieved at step 610 and a determination is further made of whether a report section of the same type as the report section type parameter 310 of the next text block 302 is indicated by the selected report structure.

If it is determined at step 608 that all the text blocks 302 of the selected text macro 300 have been verified and since it was determined that the report section types of the same types as the report section type parameter 310 associated to each of the required text blocks 302 of the selected text macro 300 is indicated by the selected report structure, then the selected report structure is determined to be compatible with the selected text macro 300 at step 612.

It will be appreciated that according to some exemplary embodiments, if any one of the report section types 310 of the required text blocks 302 of the selected text macro 300 is not found in the selected report structure, the selected report structure will be found to be incompatible.

It will also be appreciated that according to some exemplary embodiments, if all the types included in the report section type parameters 310 associated to the required text blocks 302 are a subset of the available report section types indicated by the selected report structure, the selected report structure will be found to be compatible with the selected text macro 300.

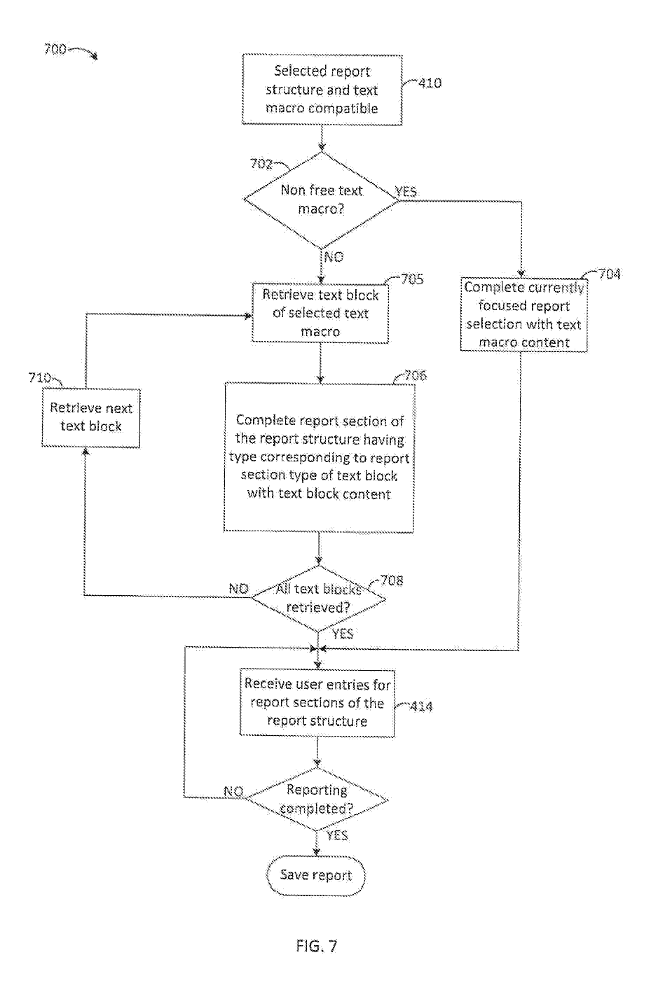

Referring now to FIG. 7, therein illustrated is a schematic diagram of a method 700 according to some exemplary embodiments for updating report sections created for the selected report structure with content from the selected text macro 300. For example, various steps of the method 700 may be performed as part of step 412 for updating report sections of selected report structure with content of the selected text macro. For example, steps of method 700 may be performed by the reporting module 118 of the medical report generation system 100.

For example, after having selected a report structure at 404 and received a text macro selection at 408, and having determined that the two are compatible at 410, a first determination may be made at 702 of whether the selected text macro 300 is a free-text text macro.

Since a free-text macro may be used to update any report section irrespective of the report section type, a way is provided to determine where the content of the free-text text macro 300 specific should be inserted. According to some exemplary embodiments, content of the free-text text macro 300 may be used to update at 704 the created report section associated with the observation entry box 202 that is currently focused, for example either selected or highlighted by the user on the user interface 114.

After updating the report section associated with the currently focused observation entry box 202, the method proceeds to 414 to receive user entries for report sections yet to be completed or to update already populated report sections. However, it will be appreciated that more than one free-text text macro may be sequentially selected for the same selected report structure to populate more than one created report section. A free-text text macro may also be selected for completing the reporting of a medical procedure in addition to selection of a text macro 300 that has text blocks 302 associated with specific report section types.

If it is determined at 702 that the selected text macro 300 contains text blocks 302 that have defined report section type parameter 310, the next text block 302 is retrieved at 705. If no text blocks 302 have yet been retrieved, the first text block 302 is retrieved.

At 706, the created report section of the type matching the type Indicated in the report section type parameter 310 associated to the text block 302 retrieved at step 705 is populated by entering the observation entry field 304 of that text block 302.

At 708, it is determined whether all the text blocks 302 of the selected text macro 300 have been retrieved and the observation entry fields 304 of the text blocks 302 have been used to populate a created report sections of a matching type. If all the text blocks 302 have been retrieved, then updating of the sections is complete and the method proceeds to step 414 to receive user entries into the observation entry boxes 202 for further populating or updating of report sections created for the selected report structure.

If all the text blocks 302 have not been retrieved, the next text block 302 is retrieved at 710 for updating the report sections created for the selected report structure. Retrieval of text blocks 302 is repeated until all the text blocks 302 have been retrieved and the fields of the text blocks have been entered into corresponding observation entry boxes 202.

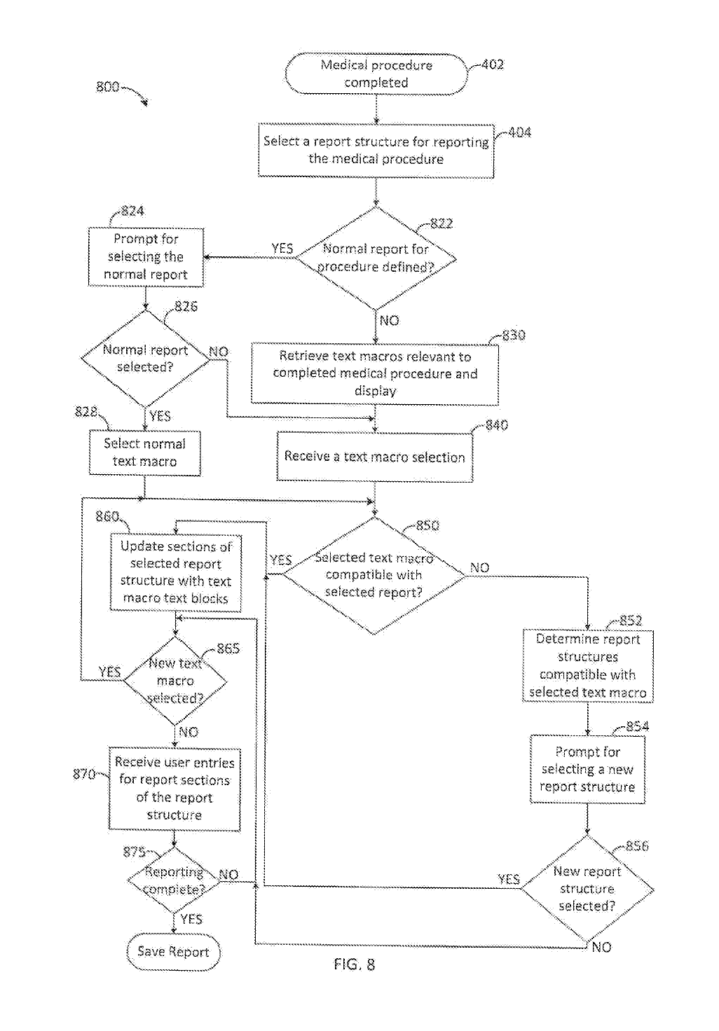

Referring to FIG. 8, therein illustrated is a schematic diagram of a method 800 for completing a medical record according to some exemplary embodiments. The method 800 is similar to the method 400 but is more detailed in that it shows in one aspect the steps for selecting a normal report. It also shows in another aspect, steps for selecting a report structure when the selected text macro 300 is not compatible with the selected report structure. However it will be appreciated that both additional aspects need not necessarily be included together in exemplary embodiments. For example some exemplary embodiments may only have the additional steps for selecting a normal report while other exemplary embodiments may only have the additional steps for selecting a new report structure.

At 402, a medical procedure performed on modality 102 is completed. For example, one or more medical images and one or more measurements taken during the medical procedure may be stored within a medical record in medical records database 106.

At step 404, a report structure that corresponds to the received medical record creation request is selected. Selection of the report structure may be performed by the report structure selection module 116 according to exemplary methods described above.

According to embodiments where a normal report may be selected, at step 822 it is determined whether a normal report is defined for the completed medical procedure. A normal report may represent a report, which may include a text macro and/or a report structure, that is most often used, or that fits a particular sectional reporting standard. For example, normal reports may be stored in a normal report database or locally stored within the text selection module 114. For example, a normal report may indicate a unique report that is standard for the specific medical procedure that is completed. The normal report may indicate a normal text macro to be selected. The normal report may also indicate a normal report structure to be selected with the completed medical procedure.

According to some exemplary embodiments, a normal report is presented for selection by the user in order to report that the results of the medical procedure are normal. As it will be appreciated, a normal report is particularly useful as a time-saving tool because for many types of medical procedure the results will in a majority of cases be normal. As a result, in many instances the user will be entering the same observations in the medical record to indicate that the results are normal and will therefore benefit from the normal report as being a quickly accessible tool for entering these observations. Furthermore, since the same observations are to be entered each time the results are normal, only one normal report is made available for selection by the user for a particular completed medical procedure to be reported. Therefore, when defining text macro to be a normal report, a verification may be made to ensure that another normal report has not already been defined that would cause a conflict.

For example, in some exemplary embodiments, only one normal report is defined for a particular procedure type such that only that normal report can be selected. However, in other exemplary embodiments, more than one normal report may be defined for a particular procedure type but each normal report defined is associated with a unique rank with respect to other normal reports defined for the same procedure type. For example, normal reports defined for the same procedure type may be each provided with unique user-level metadata. The normal report having the highest ranked user-level metadata is retrieved and made available for selection by the user.

For example, a first normal report can be defined for a particular medical procedure type and associated with the particular user account of the user, a second normal report can be defined for the same medical procedure type and associated with a task assignment group to which the user account belongs to, and a third normal report can be defined and associated with the system that includes the task assignment group. In such a case, the normal report being associated with the user account is retrieved for selection by the user because it is the highest ranked and the most specific. If no normal report is defined for the user account, then normal report being defined for the next most specific user level is selected for retrieval.

According to some exemplary embodiments, where a normal report is defined, a prompt may be displayed on user interface 114 at 824 to prompt the reporting user to decide whether the normal report should be selected or not. Alternatively, normal report may be made available for selection on user interface 114. For example, normal report may be displayed separately from other relevant text macros that are retrieved and made available for selection on the user interface 114.

At step 826, it is determined whether the normal report has been selected. If the normal report is not selected, the method proceeds to 830 and the text macros that are relevant to the completed medical procedure are displayed and selection of a text macro made by the user is received at step 840. At step 826, if the normal report is selected, then the normal text macro indicated in the normal report is selected at step 828. According to some embodiments the normal report also includes a normal report structure and the normal report structure is also selected.

According to some exemplary embodiments, where a normal report is defined, the normal report may be automatically selected. For example, the text macro indicated by the normal report may be automatically selected. As it will be appreciated, when the normal report represents a report that is often used or that is required for a particular sectional reporting structure, automatic selection of the normal report allows further economy in the amount of time required from the user to complete reporting of the medical procedure.

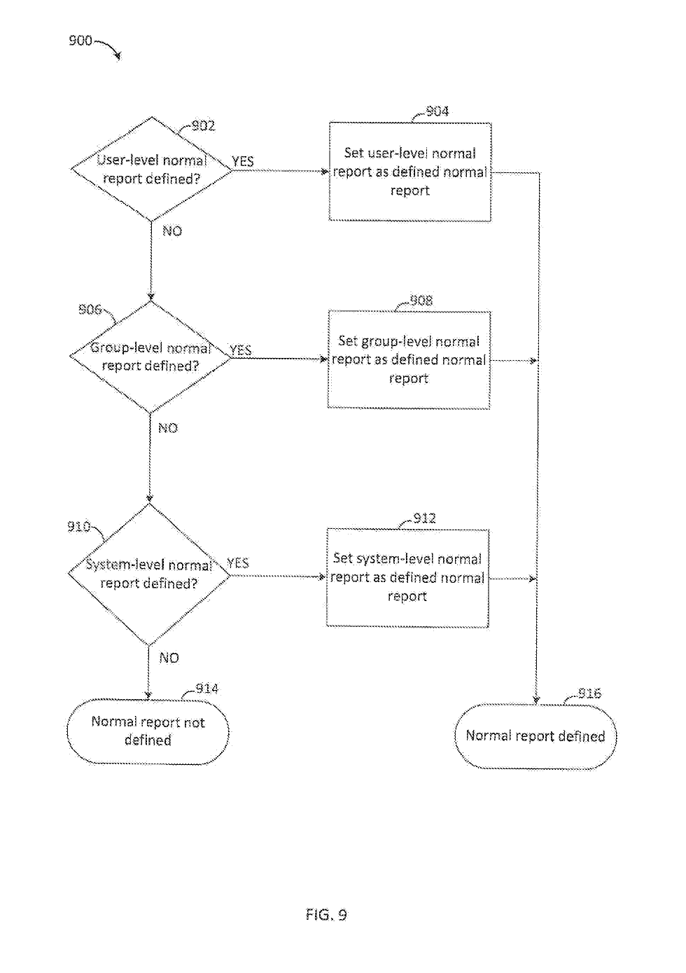

Referring now to FIG. 9, therein illustrated is a schematic diagram of the steps of an exemplary method 900 for selecting a normal report based on the specificity of the user-level property. For example, various steps of method 900 may be performed as part of step 822 for determining whether a normal report is defined for the completed medical procedure.

For example, at 902 it is determined whether a normal report having user-specific property that matches the current user or user group is defined. If the user-specific property matches, at 904 that normal report is defined as the normal report and it is determined at 916 that a normal report is defined.

If such a normal report is not defined, at 906, it is determined whether a normal report having a group-specific property that matches the group defined for the current user or user group is defined. For example, a user may not have any normal reports defined specifically for his or her user account such that no normal report having user-specific property that matches the user account will be found at 902. However, since the user account of the user may be associated with a specific group, such as all users of the internal medicine department, a normal report having a matching group-specific property may be found at 906.

If a normal report having a matching group-specific property is found at 906, at step 908 the group-level normal report is defined as the normal report for the completed medical procedure and it is determined at 916 that a normal report is defined.

If no normal report having a matching group-specific property is defined, at step 910, it is determined whether a normal report having a system-specific property that matches the system defined for the current user or user is defined. If such a normal report is found, at 912 the system-specific normal report is defined as the normal report for the completed medical procedure and it is determined at 916 that a normal report is defined.

If no system-specific property is defined, and the system-specific property is the least specific property, it will be determined at 914 that no normal report is defined for the completed medical procedure to be selected. As will be appreciated, the determination of the normal report is based upon the rank of the unique user-level metadata for each of the normal report, with the highest-ranked user-level specific normal report being defined as the normal report for the completed medical procedure.

Returning to FIG. 8, after either selecting the text macro of normal report at step 828, or selecting a text macro from the retrieved relevant text macros at step 840, a determination is made at step 850 of whether text macro selected at either step 828 or 840 is compatible with the currently selected result structure. For example, determination of whether the selected text macro is compatible with the selected report structure may be made according to the steps described in method 600 shown in FIG. 6. For example selected text macro can be determined to be compatible if all the required text blocks 302 is a subset of the report section types indicated by the selected report structure.

If it is determined at 850 that the selected text macro is compatible with the selected report structure, the method continues to 860. At 860, report sections are populated by the observation entry fields 304 of the text blocks 302 being associated with a matching report section type. For example populating of report sections may be performed similarly to the updating at 412 of FIG. 4.

At 865, it is determined whether the user has selected another text macro 300. For example, after relevant text macros are retrieved and displayed and a selection of a text macro 300 is made from the retrieved relevant text macros 300, the relevant text macros may continue to be displayed such that an alternate selection of a text macro 300 may be made. Where another text macro has been selected at 865, the method returns to 850 to determine whether the newly selected text macro is compatible with the currently selected text macro. For example, determination of whether the user has selected another text macro 300 may be made periodically until the reporting of the medical procedure is completed.

If another text macro is not selected at 865, user entries are received at 870. For example, receiving of user entries may be performed in a similar manner to the receiving of user entries at 414.

At 875, it is determined whether the reporting of the medical procedure is completed. For example, completion of reporting may be indicated by the user selecting a save function. If the report has not yet been completed, the method returns to 865 to monitor for selection of new text macro 302 and for receiving manually entered observation entries.

According to some exemplary embodiments where a further selection of a report structure can be made, if it is determined at 850 that the selected text macro is not compatible with the selected report structure, at 852 a further search is made for determining other report structures that are compatible with the currently selected text macro 300. For example, a scan of the report structure database 112 may be carried out, for example by the report structure selection module 116 to identify additional report structures that are compatible with the selected text macro. For example, a report structure may be determined to be compatible if the types of report sections indicated by that report structure includes all of the types of report sections type parameters 310 associated to the text blocks 302 that are required within the selected text macro 300.

At step 854, the report structures retrieved at step 852 that are compatible with the selected text macro 300 are presented to the user, for example, via user interface 114. The user may further be prompted to make a selection of another report structure.

At 856, it is determined whether the user has made a selection from the report structures retrieved at 852. If another report structure has been selected at 856, report sections are created for each of the types of report sections indicated by the selected report structure. Then at 860, report sections created for the newly selected report structure are populated by the observation entry fields 304 of the text blocks 302 being associated with matching report section types of the selected text macro 300.

If another report structure has not been selected, a warning message is presented, for example, via the user interface 114 that the selected text macro cannot be applied to the currently selected report structure. At step 865, it is further monitored to determine whether another text macro 300 has been selected. If no text macro 300 is selected, it will be appreciated that the reporting may still be completed by having the user manually populate each of the report sections created for the selected report structure at step 870.

According to some embodiments, to further simplify the task of a user and to shorten the time required for completing the reporting, section-specific text macros may be used to update report sections of a selected report structure. A section-specific text macro refers to a particular type of text macro that only has one text block 302 that is associated with a particular report section type. For example, each text macro may further comprise a section specific meta-data 320 to indicate whether or not the text macro is section-specific. Accordingly, the section-specific text macro 300 is used to only populate one created report section that has a matching report section type.

For example, created report sections can be updated with these text macros even prior to the user making a selection of a text macro 300 for reporting the completed medical procedure.

For example, when analyzing a plurality of available text macros in order to retrieve those text macros relevant to the completed medical procedure, for example at 406 of FIG. 4 or 830 of FIG. 8, the text macro selection module 110 can also determine whether each available text macro is a section-specific text macro. This determination may be made by checking the section specific parameter 320 of the text macro 300. When a section-specific text macro is found, a further check is made to determine whether the report section type parameter 310 of the one text block 302 of the text macro 300 matches any one of the report section types indicated by the selected report structure. A check is also made to determine whether the section-specific text macro is not restricted to a particular medical procedure type and is applicable to all medical procedure types.

For example, each of the procedure-specific metadata 332 can be undefined to indicate that the text macro 300 can be applied for any medical procedure irrespective of the context of use (procedure definition, modality or body part). Alternatively, the text macro may further comprise a “context defined” metadata to indicate whether the text macro is defined for a specific context of use or not. It will be appreciated that when the text macro 300 is not defined for a specific medical procedure type or medical procedure context, the text macro can be safely used to update a report section of the medical record without erroneously being used for a type of medical procedure for which it was not intended.

Accordingly, when a section-specific text macro is found that has a text block 302 associated with a report section type parameter 310 that matches one of the types of report sections indicated for the selected report structure, and that the text macro 300 is applicable to all medical procedure type, in some embodiments the report section of the medical report having a matching type is immediately updated with the observation entry field 304 of the text block 302.

In some embodiments, where the medical record to be stored has not yet been created, a medical record comprising at least the report section to be populated by the text block 302 of the matching section-specific text macro is created prior to updating the report section of the medical record. For example, information such as date and time of the medical procedure, patient identification information, medical practitioner who conducted the procedure are types of report sections that are consistently uniform irrespective of the type of medical procedure to be reported. It will be appreciated that for a user reporting the completed medical procedure, the retrieval of section-specific text macros and updating report sections with the text blocks of the section-specific text macros will appear as if the observation entry boxes 202 have been automatically filled.

In some exemplary embodiments, retrieval of section-specific text macros may be done in a step that is separate from the retrieval of text macros. For example, section-specific text macros may be separately stored from the available text macros for user selection in order to be easily retrievable. At any point prior to receiving a selection of a text macro 300 from the retrieved relevant text macros, a search of the section-specific text macros can be made to identify those section-specific text macros that can be used for “pre-filling” report sections of the medical record. Section-specific text macros are particular useful for quickly filling report section types that are present for different types of medical procedures and where the observation entry will be consistently the same even though the medical procedures are different.

In some exemplary embodiments, it is possible to conduct multi-procedure reporting. That is, it is possible to simultaneously report on a plurality of completed medical procedures within a single reporting task. Where the reporting task is session based, it is possible to conduct reporting of the medical procedures within a single session. For example, a medical order for a single patient can include a plurality of procedures related to the same condition. For example, within the same medical order, a patient may have undergone three separate medical procedures consisting of trauma images, chest x-ray, and extremities x-rays. A medical professional may wish to view the results simultaneously and with the ability to compare the results. For example, the results of the procedures may be related and provide information regarding the patient's overall condition.

In some cases, it is possible to conduct multi-procedure reporting across multiple medical orders for the same patient. For example, a patient may have undergone medical procedures on different dates for the same condition such that the medical procedures are classified within different medical orders. This may be the case where different medical procedures must be conducted at different medical facilities and therefore form part of different medical orders. In other cases, a first medical order may have been carried out on a patient at an initial stage and subsequent orders are carried out at a later date as a follow-up, for example, to monitor the patient's recovery. Multi-procedural reporting across multiple medical orders can be effective for efficient and comparative analysis of a patient. It will be understood that multi-procedural reporting includes both reporting a plurality of completed medical procedures from the same medical order within a single reporting task or the reporting of a plurality of medical procedures from across multiple medical orders within a single reporting task. In many cases, multi-procedure reporting can provide efficiency, consistency, and improved professional analysis due to the professional being able to report comparatively across multiple procedures.

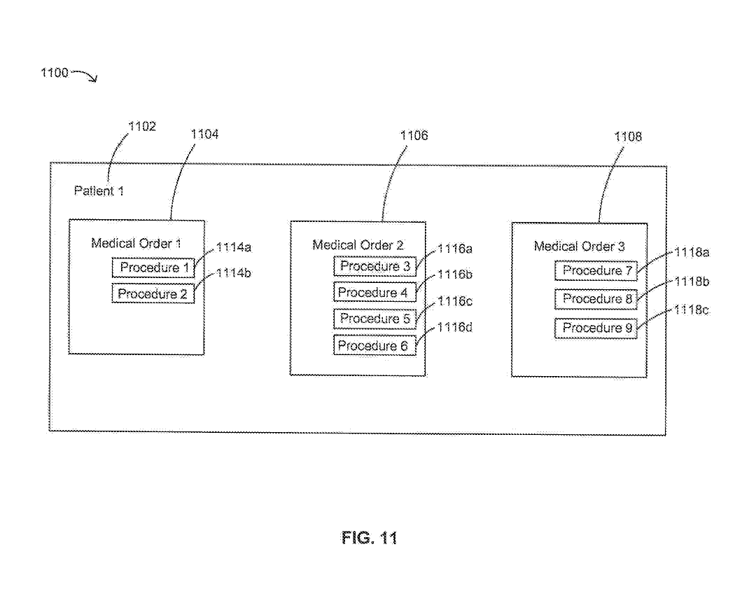

Referring now to FIG. 11, therein Illustrated is a schematic diagram of an exemplary data structure 1100 for storing unreported medical procedures. For example, the unreported medical procedures may be stored in medical records database 106.

One or more stored unreported medical orders can be associated with a single patient. The patient can be identified with a patient identifier 1102. For example, first medical order 1104, second medical order 1106, and third medical order 1108 are associated with the patient having the patient identifier 1102 “Patient 1”. For each completed medical order, one or more completed medical procedures can be associated with that medical order. As shown, a first completed medical procedure 1114a and a second completed medical procedure 1114b are associated with the first medical order 1104. A third completed medical procedure 1116a, a fourth completed medical procedure 1116b, a fifth completed medical procedure 1116c, and a sixth completed medical procedure 1116d are associated with the second medical order 1106. A seventh completed medical procedure 1118a, an eighth completed medical 1118b, and a ninth completed medical procedure 1118c are associated with third medical order 1108.

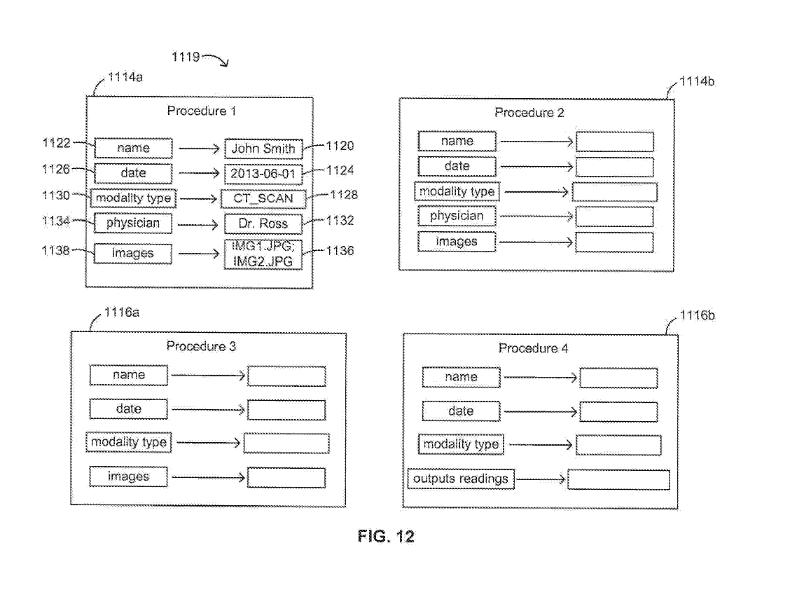

Referring now to FIG. 12, therein illustrated is a schematic diagram of an exemplary data structure 1119 for storing the outputs of the unreported medical procedures. Each unreported medical procedure is stored to include data identifiers and data entries. Each data entry is identified by its corresponding data identifier. Data entries can correspond to the results of the performed medical procedures. For example, first medical procedure 1114a has five data entries. The first medical procedure 1104a has a first data entry 1120 identified by the identifier “patient name” 1122, a second data entry 1124 identified by the identifier “date” 1126, a third entry 1128 identified by the identifier “modality” 1130, a fourth entry 1132 identified by the identifier “physician” 1134, and a fifth entry identified by the identifier “images” 1138. Data entries can be in different formats depending on the type entries. For example, the entries “patient name” 1122, “date” 1126 and “modality” 1130 can be text entries, while “images” entry 1138 are digital images, which may be DICOM format images. Second medical procedure 1114b, third medical procedure 1116a and fourth medical procedure 1116b similarly have data entries that are identified by a data identifier. It will be appreciated that different completed medical procedures will have different types of data entries. For example, fourth completed medical procedures may be a bone densitometry (EKG) and the outputs are numerical outputs.

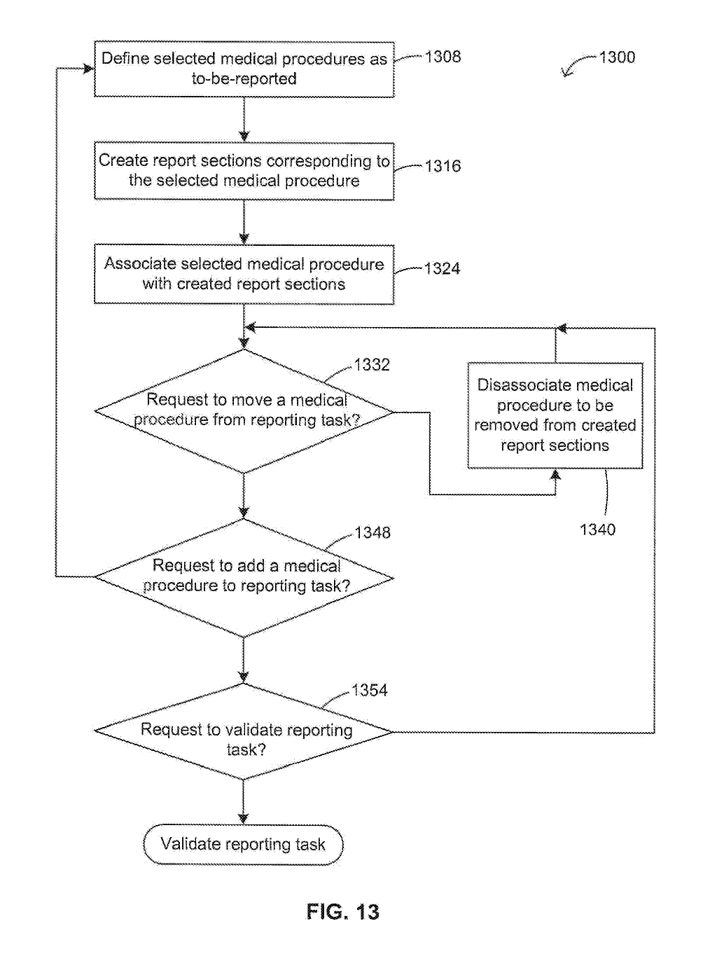

Referring now to FIG. 13, therein illustrated is a flowchart illustrating the general operational steps of an exemplary embodiment of a method 1300 for multi-procedural reporting. At step 1308, one or more medical procedures that are selected to be reported are defined as “to-be-reported”. A medical procedure defined as “to-be-reported” herein refers to a medical procedure that has been included in the reporting task and for which a medical professional is expected to review the procedure outputs (data entries) of the medical procedure. The medical professional then provides their observations on the results. These entered observations are to be included in the validated medical record that is generated for each medical procedure defined as “to-be-reported”.

For example, a user can make via the user interface 114 a selection of one or more medical procedures that are to be included as part of the “multi-procedural” reporting task. The selection can be received at the reporting module 118.

According to one exemplary embodiment, when the user-made selection is received, and the selected medical procedure belongs to a medical order that has a plurality of medical procedures, at least one other medical procedure belonging to the same medical order is automatically also defined as a medical procedure that is to-be-reported. In some cases, all medical procedures belonging to that medical order are automatically defined as medical procedures that are to-be-reported. Additional user-made selections of additional medical procedures that are to be reported can also be received. For example, the additional medical procedures that are to be reported can be from a different medical order than the medical order of the medical procedure that is first selected by the user as “to-be-reported”.

When selecting additional medical procedures as “to-be-reported”, a medical procedure may be selected independently of the medical order to which the medical procedure belongs. That is, a particular medical procedure may be added to a reporting task without having to add the other procedures in the same medical order as the particular medical procedure. It will be understood that multi-procedural reporting can simultaneously report on portions of a plurality of medical orders.

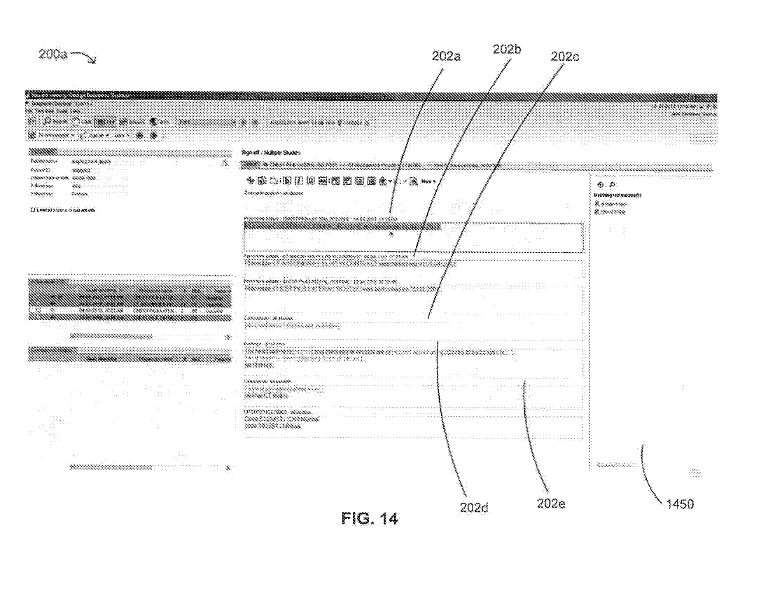

Referring now to FIG. 14, therein is illustrated is a schematic diagram of an exemplary user interface 200a of the reporting module 118. For example, after receiving a selection of the first medical procedure that is to be reported, identifiers of one or more medical procedure of the same medical order or of one or more other medical orders that are associated to the same patient can be retrieved. These identifiers can then be presented on the user interface and made available to the user for selection as additional medical procedures that are to be reported with the same reporting task.

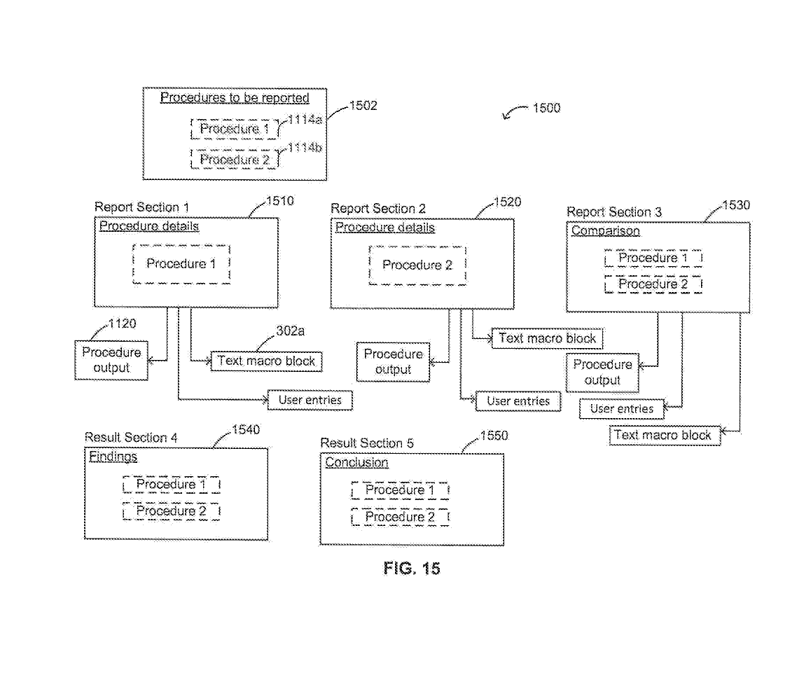

Referring now to FIG. 15, therein illustrated is a schematic diagram of a data structure 1500 for tracking medical procedures that have been defined as to-be-reported. For example, during the reporting task, a list 1502 of medical procedures defined as to-be-reported is maintained. According to the example shown in FIG. 15, a user has selected the first medical procedure 1114a of the first medical order 1104 to be included in the reporting task to define first medical procedure 1114a as to-be-reported. Accordingly, an entry identifying the first medical procedure 1114a is made in the to-be-reported list 1502. Where the reporting module 118 is configured to automatically add procedures belonging to the same medical order to the reporting task, second medical procedure 1114b also belonging to first medical order 1104 is automatically defined as “to-be-reported”. For example, an entry identifying the second medical procedure 1114b is also made in the to-be-reported list 1502.

Referring back to FIG. 13, at step 1316 a plurality of report sections corresponding to the medical procedures defined as “to-be-reported” are created. For at least one of the medical procedures defined as “to-be-reported”, a corresponding report structure is retrieved and the report sections of the types indicated by the retrieved report structure are created.

According to some exemplary embodiments, for each of the medical procedures defined as to-be-reported, a corresponding report structure is retrieved and the report sections of the types indicated by the retrieved report structures are created. For example, retrieval of report structures can be made according to U.S. provisional application No. 61/605,458, which is hereby incorporated by reference. Accordingly, a set of report sections is created for each of the medical procedures defined as to be reported. Accordingly, the report sections that are created is a union of the sets of types report sections indicated in the report structures retrieved for the plurality of medical procedures defined as “to-be-reported”.

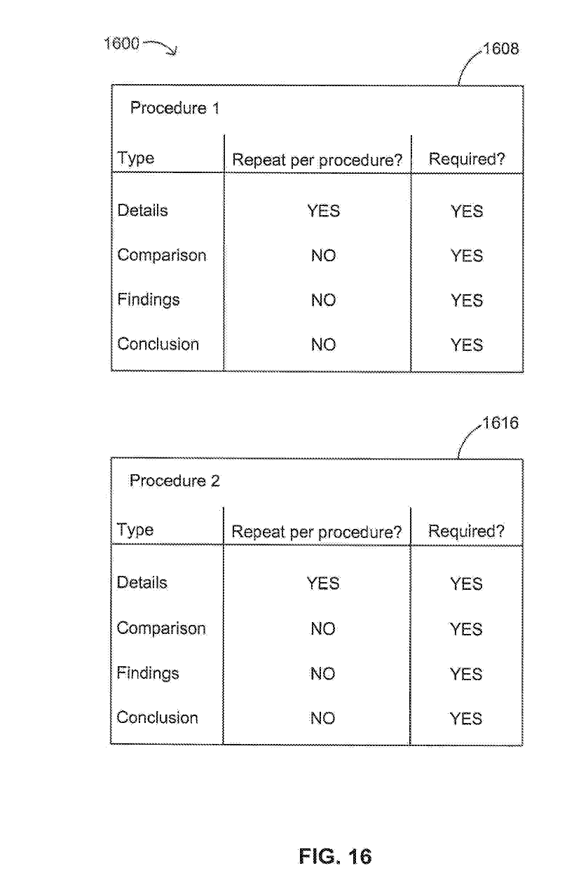

Referring now to FIG. 16, therein illustrated is a schematic diagram of an overall data structure 1600 having an exemplary report structure 1608 retrieved for the first medical procedure 1114a and a schematic diagram of an exemplary report structure 1616 retrieved for the second medical procedure 1114b. First report structure 1608 retrieved for the first medical procedure 1114a indicates that a report section of the type “procedure details”, a report section of the type “comparison”, a report section of the type “findings”, and report section of the type “conclusions” are to be created. The report section of the type “procedure details” is specified as “repeat per procedure”. The report sections of the types “findings”, “conclusions”, and “comparison” are specified as “multi-procedural”. Each of the types of report sections indicated in the first report structure 1608 are defined as required for completion of the reporting task.

The second report structure 1616 retrieved for the second medical procedure 110 defines that a report section of the type “procedure details”, a report section of the type “comparison”, a report section of the type “findings”, and a report section of the type “conclusions” are to be created. The report section of the type “procedure details” is specified as “repeat per procedure”. The report sections of the type “findings”, “conclusions”, and “comparison” are specified as “multi-procedural”. Each of the types of report sections indicated in the second report structure 1616 are defined as required for completion of the reporting task.

Where one type of report section indicated in a report structure is specified as “repeat per procedure”, a new report section corresponding to the type indicated in the report structure is created. Where the type of report section is indicated in more than one report structures, a new report section is created for each of instances that the type is indicated in the report structures. This report section has a one-to-one relationship with the medical procedure for which the report structure was retrieved.

Where one type of report section indicated in a plurality of report structures is specified as “multi-procedural”, the report section is created only once. Where the type of report section is indicated in more than one report structures, the report section is still created only once. In this case, the created report section has a one-to-many relationship with the plurality of medical procedures for which the plurality of report structures was retrieved.

Referring back to FIG. 15, the report sections corresponding to the types indicated in the retrieved first report structure 1608 and in the retrieved second report structure 1616 are created. A report section 1510 of the type “procedure details” for the first medical procedure 1114a is created. A report section 1520 of the type “procedure details” for the second medical procedure 1114b is also created. It will be appreciated that even though report section 1510 and report section 1520 are both of the type “procedure details”, because the retrieved report structures specify these types of report sections as “repeat per procedure”, the report sections are created once for each of first medical procedure 1114a and second medical procedure 1114b.

Continuing with FIG. 15, report section 1530 of the type “comparison”, report section 1540 of the type “findings”, and report section 1550 of the type “conclusions” are also created. It will be appreciated that report sections 1530, 1540, and 1550 are created only once even though each type is indicated in both first report structure 1608 and second report structure 1616. This is because these report sections have been specified in both first retrieved report structure 1608 and second retrieved report structure 1616 as “multi-procedural”.

Referring back to FIG. 13, at step 1324 the created report sections are associated with corresponding one or more medical procedures defined as “to-be-reported”. According to various exemplary embodiments where a report structure is selected for each of the medical procedures defined as “to-be-reported”, report sections defined by a report structure selected for a medical procedure are associated with that medical procedure.

Referring back to FIG. 15, where first medical procedure 1114a and second medical procedure 1114b have been defined “as to-be-reported”, a first subset of the created report sections are associated with the first medical procedure 1114a and a second subset of the created report sections are associated with the second medical procedure 1114b. The first subset of the created report sections correspond to the types of report sections indicated by the first report structure 1608 and the second subset of the created report sections correspond to types of report sections indicated by the second report structures 1616. For purposes of providing an example, an association of a created report section with a “to-be-reported” medical procedure is shown by including an identifier of the appropriate medical procedure in the dotted box denoting a report section. However, it will be understood that the association between the created report section and one or more medical procedure can be made according to any method known in the art.

It will be appreciated that report sections created for types specified as “repeat per procedure” are uniquely associated with one medical procedure. First report section 1510 of the type “procedure details” is associated only with first medical procedure 1114a. For example an identifier of the first medical procedure 1114a is included in the report section 1510 showed this association. Similarly second report section 1520 of the type procedure details” is associated only with the second medical procedure 1114b. For example an identifier of the second medical procedure 1114b is included in the report section 1520 to show this association.

It will be appreciated that report sections specified as “multi-procedural are defined in both first report structures 1608 and second report structure 1616. Accordingly these report structures are associated with both the first medical procedure 1114a and the second medical procedure 1114b. For example, third report section 1530 of the type “comparison”, fourth report section 1540 of the type “findings”, and fifth report section 1550 of the type “conclusion” are each associated with both the first medical procedure 1114a and the second medical procedure 1114b. It will be further appreciated that where two selected report structures, such as first report structure 1608 and second report structure 1616, share at least one common type of report section and that that type of report section is specified as “multi-procedural”, a resulting report section that is created will be associated with both the first medical procedure and the second medical procedure. The created report section that is associated to both the first medical procedure and the second medical procedure belongs to an intersection of the first subset of the report sections created for the first medical procedure 1114a and the second subset of report sections created for the second medical procedure 1114b.

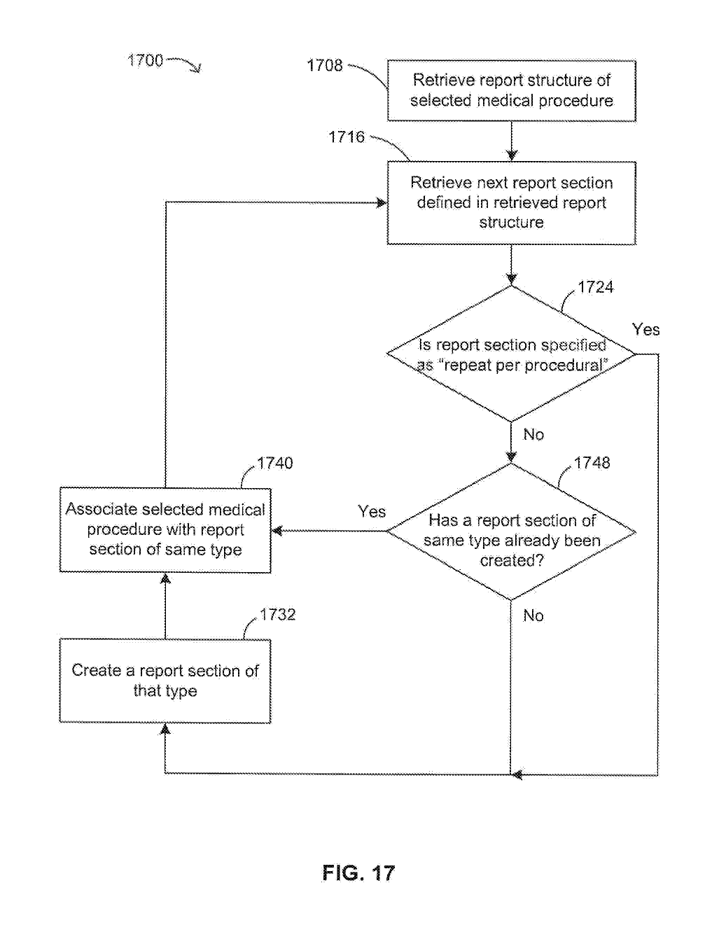

Referring now to FIG. 17, therein illustrated is a flowchart of exemplary embodiments of a method 1700 for carrying out steps 1316 and 1324 of method 1300 for one selected medical procedure that is to be reported within the reporting task.

At step 1708, the report structure for the to-be-reported medical procedure is retrieved. For example, report structure selection module 116 can retrieve the particular report structure from local storage or from a report structure database 112.

At step 1716, the next report section type indicated in the report structure is retrieved and the type of the report section is determined. For example, the reporting module 118 can retrieve the next report section type. Where no report section types have been retrieved, the first report section type indicated in the particular report structure is retrieved.

At step 1724, it is determined whether the retrieved report section type is specified as “repeat per procedure”. If the report section type is not specified as “repeat per procedural”, then it is determined that it is specified as “multi-procedural”.

If it is determined at step 1724 that the retrieved report section type is defined as report per procedure, the method proceeds to step 1732 to create a new report section corresponding to that type. For example, when carrying out steps 1316 and 1324 for the second report structure 1616 retrieved for the second medical procedure 1114b, a new report section of the type “procedure details” is created at step 1732 since the second report structure 1616 specified that the type “procedure details” is “repeat-per-procedure”. Furthermore, at step 1740, the newly created report section is associated with the second medical procedure 1114b.

If it is determined at step 1724 that the retrieved report section type is defined as “multi-procedural”, the method proceeds to step 1748.

At step 1748, it is determined whether a report section of the same type as the presently retrieved report section type has already been created. If it is determined that a report section of the same type has already been created, the method proceeds to step 1740 to associate the selected medical procedure with the already created report section of the same type. For example, when carrying out steps 1316 and 1324 for the second report structure 1616 retrieved for the second medical procedure 1114b and when the report section type “comparison” is retrieved, it is determined that a report section of the type “comparison” has already been created for the first medical procedure 1114a. Furthermore, the first medical procedure 1114a is already associated with the created report section 1530 of the type “comparison”. Accordingly, at step 1740, the second medical procedure 1114b is further associated with the already created report section 1530 of the type “comparison”.

If it is determined that a report section of the same type has not already been created, the method proceeds to step 1732 to create a new report section corresponding to that type. Furthermore, at step 1740, the newly created report section is associated with the second medical procedure 1114b.

After completing association of the selected medical procedure with the created report section, the method returns to step 1716 to retrieve the next report section type indicated in the particular structure. If there are no more next report section types, creation and association of report sections for the particular report structure and medical procedure is complete for the time being.

According to various exemplary embodiments, an observation entry box 202 can be presented for each of the created report sections. Referring back to FIG. 14, an observation entry box 202a is created for the report section 1510 and has the identifier “procedure details” for first medical procedure 1114a, which is identified as “CHEST PA & LATERAL: ROUTINE”. An observation entry box 202b is created for the second report section 1520 and has the identifier for “procedure details” for second medical procedure 1114b, which is identified as “CT ABDOMEN & PELVIS W CONTRAST”. An observation entry box 202c is created for the third report section 1530 and has the Identifier “comparison”, an fourth observation entry box 202d is created for the fourth report section 1540 and has the identifier “findings”, and a fifth entry observation entry box 202e is created for the fifth report section 1550 and has the identifier “conclusion”, A user can make entries into one or more of the observation entry boxes, which is then stored as an entry for the corresponding one or more report sections.

According to some exemplary embodiments, when a report section is created for a type specified as “repeat per procedure”, the observation entry box corresponding to that report section can be identified according to <section type>, <procedure name>, <order_date_time>. When a report section is created for a type specified as multi-procedural, the observation entry box corresponding to that report section can be identified according to <section type>—“all studies”.

According to some exemplary embodiments, the report sections are displayed on the user interface 114 according an order set by a reporting module administrator.

According to various exemplary embodiments, one or more text macros 300 may be selected by the user to allow the user to easily make user entries into the observation entry boxes 202 for populating or updating the report sections.

A first set of text macros 300 that are relevant to the first medical procedure 1114a can be retrieved. For example, retrieval of relevant text macros may be carried out according to the steps described in FIG. 5.

Similarly, a second set of text macros 300 that are relevant to the second medical procedure 1114b is retrieved. For example, retrieval of the second set of relevant text macros may also be carried out according to the steps described in FIG. 5.

The retrieved relevant text macros 300 may be displayed and made available for selection to a user. Referring back to FIG. 14, two retrieved text macros are displayed in an user interface sub-area 1450.

According to some exemplary embodiments, retrieved text macros 300 of the first set and retrieved text macros of the second set are further ordered prior to being displayed for selection by the user. For example, retrieved relevant text macros 300 of the first and second sets can be ordered according to which of the medical procedures was most recently completed. The retrieved text macros 300 that are relevant to the most recent medical procedure can then be given a higher order.

In some embodiments, retrieved text macros 300 may be ordered to alternate between the first set of relevant text macros 300 and the second set of relevant text macros 300 with the text macros of the set being relevant to the most recent medical procedure being given a higher order. For example, if the second procedure is more recent, relevant text macros of both sets can be ordered according to:

First text macro for procedure 2;

First text macro for procedure 1;

Second text macro for procedure 2;

Second text macro for procedure 1;

Third text macro for procedure 2;

Third text macro for procedure 1.

The retrieved text macros 300 from both the first set and the second set are then displayed on user interface 114 according to the established order for selection by the user. It will be appreciated that ordering of the relevant text macros for the multiple medical procedures allows the most relevant text macros to be given primacy when presented to the user, which further allows the user to quickly access the most relevant text macros.

A first text macro selection request can be received which indicates a user-selected text macro which has been selected from among the text macros relevant to the first medical procedure. A determination is made as to whether the first selected text macro is compatible with the selected first report structure for the first medical procedure. Where the first selected text macro is compatible, each of the report sections created for the first report structure are updated with the corresponding text blocks of the first selected text macro.

Similarly a second text macro selection request can be received which indicates a text macro that the user has selected from among the text macros relevant to the second medical procedure. A determination is made for whether the second selected text macro is compatible with the selected second report structure for the second medical procedure. Where the second selected text macro is compatible, each of the report sections created for the second report structure are updated with the corresponding text blocks of the second selected text macro.

Referring back to FIG. 15, a first text block 302a of a retrieved text macro 300 that corresponds with the first created report section 1510 is associated with that report section 1510. As described herein, text macros assist the user to populate the created report sections. For purposes of providing an example, an association of the first created report section 1510 with a corresponding text block 302a is shown by an arrow joining the box corresponding to the first report section 1510 with an identifier of the text block 302. For example, a text block 302 is identified according to the identifier of its parent text macro 300 and its ordering within the parent text macro 300. The association between the created report section 1510 and a corresponding text block 302 can be made according to any method known in the art.

Continuing with FIG. 15, each created report section is further associated with user entries received in the observation entry boxes 202 corresponding to the report section. It will be appreciated that for a report section associated to more than one medical procedure, the user entries are also associated to the more than one medical procedure. When a user or medical professional makes an observation by entering a user entry into an observation box 202 for that report section on the user interface 114, the user entry is received at the reporting module and associated with the more than one medical procedure. Therefore, the user or medical professional does not need to enter the observation many times for multiple procedures. This provides efficiency for the reporting tasks and may motivate the medical professional to enter observations having more comparative information. For example, user entries associated with third report section 1530 need to be entered only once, but become associated with both the first procedure 1114a and second procedure 1114b.

A created report section may also be associated with procedure outputs 1120 corresponding to a data entry stored with the unreported medical procedure and which is to become part of the validated medical record. Each created report section can be further associated with auto-fill entries defined in the retrieved text macro 300 and/or text block 302.

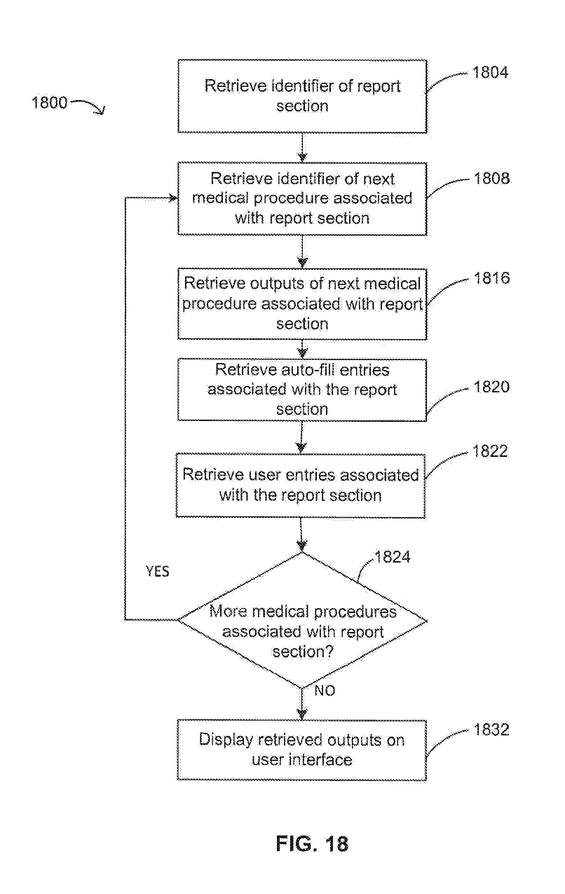

Referring now to FIG. 18, therein Illustrated is a flowchart showing the operational steps of a method 1800 for displaying the contents of a created report section within the user interface 114.

At step 1804, the identifier of the created report section is retrieved.

At step 1808, the identifier of the next medical procedure associated with the report section is retrieved. Where no medical procedures have yet been retrieved, the first medical procedure associated with the particular report section is retrieved. For example, referring back to FIG. 15, when displaying the contents of the third report section 1530, the identifier of the first medical procedure 1114a is retrieved at step 1808.

At step 1816, for the retrieved medical procedure, at least one output of the medical procedure is retrieved. For example, the at least one output is retrieved from the medical records database 106. For example, which output is to be retrieved may be determined based on the type of the created report section. Alternatively, which at least one output is retrieved is determined based on fill-in fields 304, DICOM SR Field 304, or database field 304 of the text block 302 associated with the created report section.

At step 1820, where the text macro defines at least one auto-fill entry, this entry is associated with the created report section and retrieved medical procedure. Where an auto-fill entry is already associated with the created report section, a verification may be made to determine whether the new auto-fill entry is the same as the already associated auto-fill entry. If the new auto-fill entry is the same as the already associated auto-fill entry, the new auto-fill entry is not associated with the created report section. For example, if an auto-fill entry is a text string, two auto-fill entries are determined to be the same if each character of the two strings are the same. Where the auto-fill entries are different, entries corresponding to both medical procedures can be displayed and separated by an appropriate delimiter, such as a semi-colon.

At step 1822, user entries associated with the created report section is retrieved and displayed.

At step 1824, it is determined whether there are more medical procedures associated with the report section. Where there are more medical procedures associated, the method returns to step 1808 to retrieve the next medical procedure associated with the created report section. For example, in the case of third report section 1530, after examining the first medical procedure 1808, the identifier of the second medical procedure 1114b is retrieved. Where there are no more medical procedures associated with the created report section, at step 1832 one or more of the retrieved information is displayed on the user interface 114. For example, at least an identifier of the created report section and at least one of the retrieved outputs of the medical procedure is displayed.

Alternatively, retrieved information is displayed according to the text block 302 associated with the report section. Free text field 304 of the text block 302 can be displayed along with retrieved procedure outputs defined by the fill-in field 304, DICOM SR field 304 and database field 304.

Referring back to FIG. 14, observation entry box 202c for the third report section 1530 of the type “comparison” is displayed with the heading “comparison”. The heading also includes “all studies” to indicate that the report section is for reporting on the results of all of the medical procedures defined as “to-be-reported” and included as part of the reporting task. With the entry box 202c itself, free text field 304 of text block 302 having the string “No comparison studies are available” is displayed.

A request to validate the entries of the report sections in order to create a validated medical record can be received. Accordingly a validated medical record can be created for each of the medical procedures defined as to be reported. For example, for one medical procedure defined as to be reported, examination is made to identify all of the report sections associated with that medical procedure. The entries of those report sections are then stored in a validated report sections within the medical record created for that medical procedure. Furthermore, the identifier of each report section, the identifier of the medical procedure can also be retrieved and stored within the medical record. For example, for one report section, the retrieved section identifier, the retrieved medical procedure identifier, and the retrieved at least one procedure output are stored together within one stored report section. Storage of the report sections can be made in sectional reporting format, wherein each report section has the type identifier which is further associated with a report section entry. Storage in sectional reporting format allows an individual report section of a medical record to be retrieved independently of the medical record.

When the same medical procedure is associated with two or more report sections, these report sections can be stored within the same medical record at the time of validating the reporting task. For example, following a request from a user to validate a medical record for a particular medical procedure that is part of the reporting task, a scan is made through all the report sections that are part of the reporting task to find all the created report sections that are associated to the particular record. These report sections are then stored as report section within the same medical record for the particular medical procedure.

Continuing with FIG. 14, a history tab can be made available for selection. Selecting the history tab allows visualization of task information, such as all medical tasks related to the specific procedure, their transitions, durations, user involved, as well as any report structure versions.

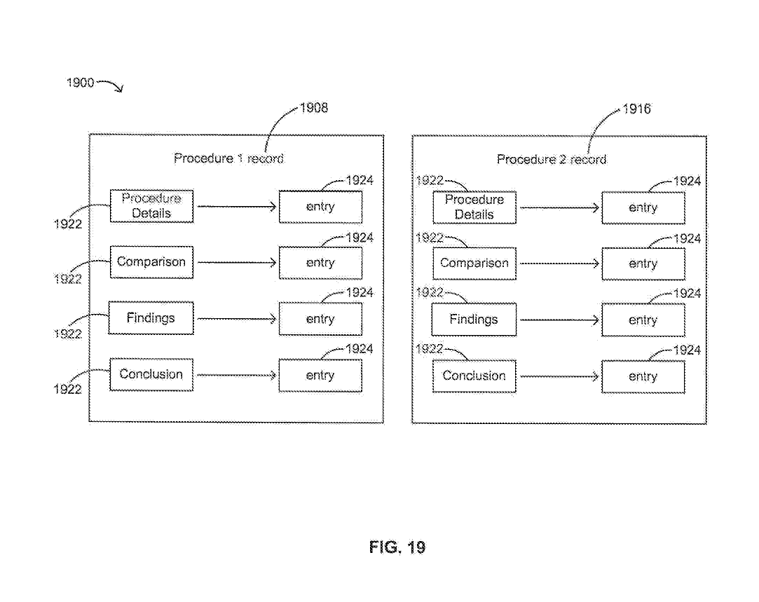

Referring now to FIG. 19, therein illustrated is a schematic diagram of an overall data structure 1900 that includes a first validated medical record 1908 created for the first medical procedure 1114a and a second validated medical record 1916 created for the second medical record 1114b. Each of the report sections shown in FIG. 19 associated with the first medical procedure 1114a are stored in the validated medical record 710 as a validated report section. Each valid report section includes a type identifier 1922 and a record entry 1924 representing the medical procedure output and observations made by the medical professional. Since report sections 1530, 1540, 1550 are associated with both the first medical procedure 1114a and the second medical procedure 1114b, these report sections are stored as validated report sections in both the first validated medical record 1908 and the second validated medical record 1916. It will be appreciated that validated medical records are created for multiple medical procedures through the carrying out of a single reporting task.

According to various exemplary embodiments, the medical procedures defined as “to-be-reported” in the current reporting task can be modified. In particular, current “to-be-reported” medical procedures can be removed from the current reporting task and/or other medical procedures can be added to the current reporting task. This modification of the medical procedure allows a user to flexibly alter how the reporting task is carried out. Referring back to FIG. 13, after initially creating report sections for the initial selection of first medical procedure and other medical procedures, additional commands from the user can be received.

A first additional command may be for undefining a medical procedure as “to-be-reported”. At step 1332, it is determined whether a user request to undefine a particular medical procedure from the current reporting task has been received. If such a request has been received, the method proceeds to step 1340 to undefine the particular medical procedure from the current reporting task. For example, step 1340 can be carried out by the reporting module 118. After undefining the particular medical procedure, the method returns to receive additional commands from the user.

For example, in response to the request for undefining a particular medical procedure, each of the created report sections that are currently associated with that particular medical procedure is disassociated from that medical procedure. Alternatively, in response to the request for undefining a particular medical procedure, each of the created report sections that are currently associated with a plurality of medical procedures that includes the particular medical procedure is disassociated from that particular medical procedure. Furthermore, that particular medical procedure is undefined as to be reported. According to various exemplary embodiments, wherein the medical procedures defined as to-be-reported are stored within a temporary list, the particular medical procedure is removed from that list.

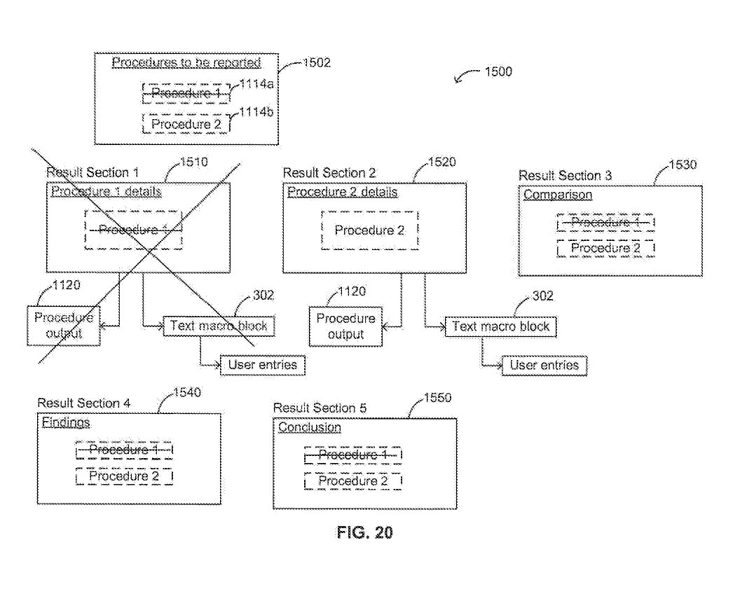

Referring now to FIG. 20, therein illustrated is a schematic diagram of a data structure for tracking medical procedures during a reporting task following a request to undefine the first medical procedure 1114a from the current reporting task. For example a request for undefining a particular medical procedure can made by the user by deselecting the first medical procedure 1114a shown on the user interface 114 as being to be reported. Following the request, the listing of the identifier first medical procedure 1114a is removed from the temporary list 1502. Moreover, each of third report section 1530 of the type “comparison”, fourth report section 1540 of the type “finding” and fifth report section 1550 of the type “conclusions” are disassociated from the first medical procedure 1114a. For example, these disassociations are denoted by the removal (crossing out) of the identifier for the first medical procedure 1114a for the boxes corresponding to the created report sections 1530, 1540, 1550. Furthermore, according to one exemplary embodiment, since the first report section 1510 of the type “procedure details” is uniquely associated with the first medical procedure 1114a, undefining of the first medical procedure 1114a as being to-be-reported also results in removal of the first report section 1510 from the current reporting task. Accordingly, the first report section 1510 is no longer considered as having been created as part of the current reporting task.

Report sections that are uniquely associated with the medical procedure to be undefined as being reported can be deleted. Alternatively, since the particular report sections will not be examined in response to a request for validating the medical records, report sections being uniquely associated with the declared medical procedure can be archived. This may be advantageous where the same medical procedure is defined again as to be reported at a later time and previously made user entries that are archived can be restored without the user having to remake the user entries.

Referring back to FIG. 13, a second additional command may be for adding a medical procedure to the reporting task. At step 1348, it is determined whether a user request to add an additional medical procedure to the current reporting task has been received. If such a request has been received the method returns to step 1308 to define the medical procedure identified in the user request as “to-be-reported”. Further at step 1316, report sections corresponding to the newly defined medical procedure are created. Yet further at step 1324, the report sections are associated with the newly defined medical procedure.

For example, additional medical procedures for the same patient but from another medical order can be displayed on the user interface 114 as suggested medical procedures to be reported. The user may make the request to further report these medical procedures by selecting one or more of the suggested medical procedures. In response to the request to add an additional medical procedure to the multi-procedural reporting task, the selected additional medical procedure is defined as to-be-reported. For example the additional medical procedure is added to the temporary list 1502 of medical procedures already defined as to be reported. Furthermore additional report sections may be created for the additional medical procedure to be reported. An additional report structure corresponding to the additional medical procedure may be selected. Where a report section type defined in the additional report structure is specified as repeat-per-procedure, a new report section can be created. Where a report section type defined in the additional report structure is specified as multi-procedural, a verification is made to determine whether a report section of the same type has already been created. If the report section of the same type has already been created, another report section is not created, and the existing report section of that type is simply associated with the additional medical procedure. If the report section of the same type has not already been created, a new report section of that type is created, and associated with the additional medical procedure.

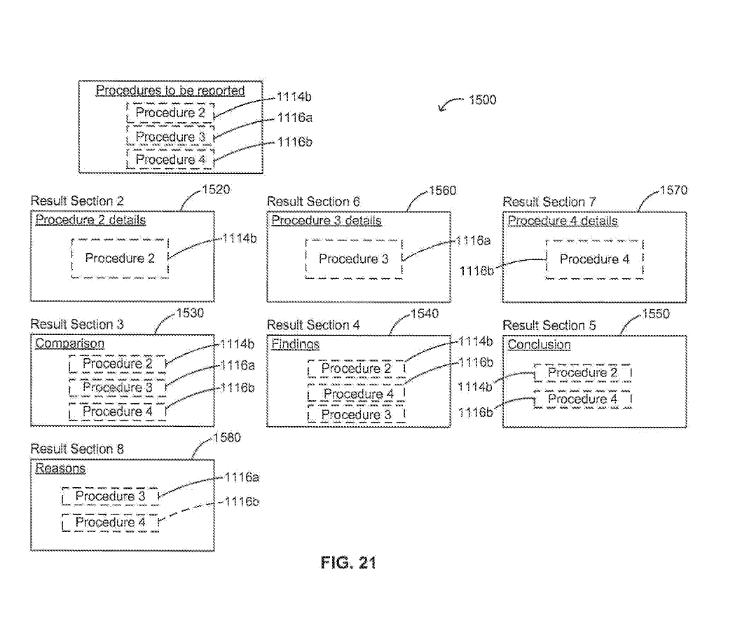

Referring now to FIG. 21, therein illustrated is the data structure according to an exemplary embodiment following requests to add third medical procedure 1116a and fourth medical procedure 1116b of the second medical order 1106 to the multi-procedural reading task. As is shown in FIG. 15, medical procedure 114 and fourth medical procedure 116 are included in the temporary list 1502 to denote that these medical procedures have been defined as to-be-reported.

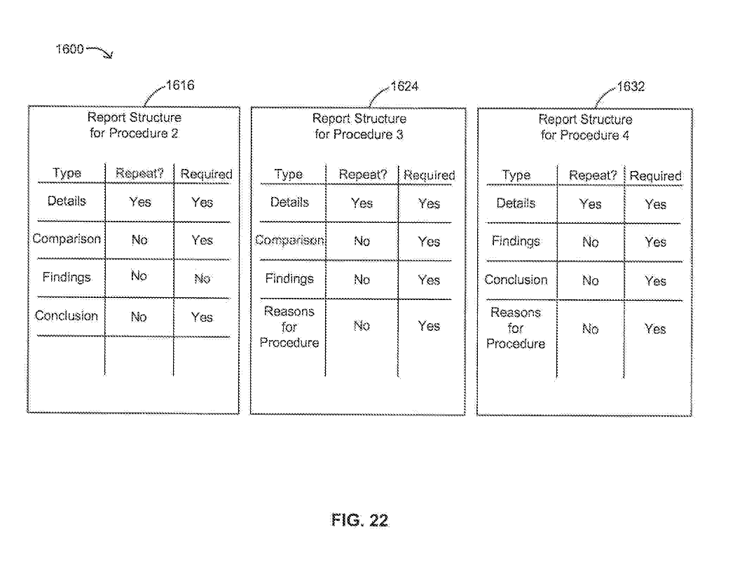

Referring now to FIG. 22, therein illustrated is exemplary report structures that can be selected for each of third medical procedure 1116a and fourth medical procedure 1116b. For example third report structure 1624 for the third medical procedure 114 defines that the report sections of the type “details, “comparison, “findings and reasons for procedure” are required. Moreover, report sections of the type “details” is specified as repeat per procedure while report sections of the type “comparison”, “findings”, and “reasons for procedure” are defined as multi-procedural.

Fourth report structure 1632 for the fourth medical procedure 1116b defines that the report sections of the type “details”, “findings”, “conclusions” and, “reasons for procedure” are required. Moreover report sections of the type “details” is specified as repeat for procedure while report sections of the type “findings”, “conclusions”, and “reasons for procedure” are defined as multi-procedural.

Referring back to FIG. 21, report sections corresponding to the types specified in the third report structure 1624 and fourth report structure 1632 are created. Since the report section of the type “procedure details” of third report structure 1624 is specified as repeat per procedure, a sixth report section 1560 of the type “procedure details” is created and uniquely associated to the third medical procedure 1116a. Similarly since the report section of the type “procedure details” of fourth report structure 1632 is specified as repeat per procedure, a seventh report section 1570 of the type “procedure details” is created and uniquely associated to the fourth medical procedure 1116b.

Report sections of the types “comparison” and “findings” are defined in both the third report structure 1624 and the fourth report structure 1632 as being required. However since these types of report section are specified as multi-procedural and corresponds to types of report sections of that have been previously created for the second medical procedure 1114b, new report sections of these types do not need to be created. Instead the existing third report section 1530 and fourth report section 1540 are associated with both the third medical procedure 1116a and the fourth medical procedure 1116b.

The report section of the type “conclusion” is defined in the fourth report structure 1632 as being required. However since this type of report section is specified as multi-procedural and corresponds to a type of report section that has previously been created for the second medical procedure 1114b, a new report sections of this type does not need to be created. Instead the existing fifth report section 1550 is associated with the fourth medical procedure 1116b.

The report section of the type “reasons” is defined in both the third report structure 1624 and the fourth report structure 1632 as being required. Furthermore, a report section for this type has not yet been created as part of the reporting task. Therefore, in response to the request to add either one of the third medical procedure 1116a or the fourth medical procedure 1116b to the current reporting task, a new eighth report section 1580 of the type “reasons” is created. Since the third report structure 1624 and the fourth report structure 1632 both define a reports section of the type “reasons” as being required, the corresponding created report section is associated with both the third medical procedure 1116a and the fourth medical procedure 1116b.

Referring back to FIG. 13, a third additional command may be for storing and validating the reported sections into a validated medical record. At step 1354, a request for validating the reporting task is received, in which case, the reporting task is validated and a medical record is created for each of the selected medical procedures defined as to-be-reported.

According to one exemplary embodiment, a list of medical procedures that are to be reported may be provided and made available for selection. Each medical procedure is linked with a reporting task for the medical procedure. Both the medical procedure and the reporting task may be presented as a list and made available for selection by a medical professional. A selection of a first medical procedure for reporting results in the initiation of the reporting task corresponding to that first medical procedure. The first medical procedure also becomes defined as to-be-reported. A second medical procedure can then be added to the ongoing reporting task for the first medical procedure. For example, the first and second medical procedures are part of the same medical order and are automatically added to the current reporting task when the first medical procedure was selected. In response to the second medical procedure being added the reporting task is made unavailable for selection. For example, where a first medical professional has selected the first medical procedure for reporting and the second medical procedure is added to the reporting task, the second medical procedure and tis corresponding reporting task are no longer available for selection by another medical professional. However, if either one or both of the first medical procedure and the second medical procedure are undefined as to-be-reported, the undefined medical procedure is made available for selection again.

Similarly, a list of reporting tasks that are to be performed may be provided and made available for selection. For example, reporting tasks may be prepared ahead of time to aid a medical professional in carrying out multi-procedural reporting. Each reporting task is linked with one or more medical procedures. For example, multiple reporting tasks may be linked with the same medical procedures. This allows a particular medical procedure to be potentially reported using multi-procedural reporting within different reporting tasks. A selection of a first reporting task results in the initiation of the reporting task. Each of the medical procedures linked to the first reporting task become defined as to-be-reported. In response to the medical procedures being defined as to-be-reported, each reporting task linked to these medical procedures are made unavailable for selection. For example, where a first medical professional has selected the first reporting task, which is linked to a first medical procedure and a second medical procedure, each reporting task linked to the medical procedures are no longer available for selection by another medical professional. However, if either one or both of the first medical procedure and the second medical procedure are undefined as to-be-reported, the reporting tasks linked to the undefined medical procedure are made available for selection again.

Exemplary embodiments for multi-procedural reporting presented herein are described with respect to a first medical procedure to be reported and a second medical procedure to be reported, however it will be understood that multi-procedural reporting may be adapted for simultaneously reporting of any number of medical procedures.

1. A method for reporting a plurality of medical procedures, the method comprising:
defining a first medical procedure and a second medical procedure as to-be-reported;
creating a plurality of report sections for the first medical procedure and the second medical procedure;
associating a first subset of the created report sections with the first medical procedure;
associating a second subset of the created report sections with the second medical procedure, at least one report section of the second subset also being associated with the first medical procedure;
receiving a request for undefining the first medical procedure as to-be-reported; and
in response to the request for undefining the first medical procedure, disassociating the first medical procedure from each of the at least one report section that is associated with the first medical procedure and the second medical procedure.

2. The method of claim 1, further comprising:
in response to the request for undefining the first medical procedure, deleting at least one report section being uniquely associated with the first medical procedure.

3. The method of claim 1, further comprising:
selecting a first report structure for the first procedure, the first report structure defining the first subset of report sections;
selecting a second report structure for the second procedure, the second report structure defining the second subset of report sections;
wherein the plurality of created report sections is defined by a union of the first subset and the second subset.

4. The method of claim 3, wherein
for at least one report section belonging to an intersection of the first subset and the second subset, the report section is created only once.

5. The method of claim 1, wherein if the first and second medical procedures belong to the same medical order, automatically defining the first medical procedure and the second medical procedure as to-be-reported.

6. The method of claim 1, further comprising:
for at least a first report section associated to a plurality of medical procedures defined as to-be-reported:
retrieving an Identifier of the report section;
for each of at least two medical procedures associated to the report section, retrieving at least one procedure output; and
displaying the retrieved section identifier and the at least one retrieved procedure output.

7. The method of claim 6, further comprising:
storing the retrieved section identifier, the retrieved medical procedure identifier, and the retrieved at least one procedure output as a stored report section.

8. The method of claim 7, further comprising:
for at least a second report section associated to a plurality of medical procedures defined as to-be-reported:
retrieving an identifier of the second report section;
for each of at least two medical procedures associated to the second report section, retrieving at least one procedure output; and
displaying the retrieved section identifier and the retrieved procedure outputs;
storing the retrieved section identifier, the retrieved medical procedure identifier, and the retrieved at least one procedure output as a stored report section; and
if the first report section and the second report section are associated with the same medical procedure, storing the first stored report section and the second stored report section within the same medical record.

9. The method of claim 1, further comprising:
defining a third medical procedure as to-be-reported;
associating a third subset of the created report sections with the third medical procedure, at least one report section of the third subset also being associated with the second medical procedure;
for at least one report section associated to a plurality of medical procedures defined as to-be-reported:
retrieving an identifier of the report section;
retrieving for each of at least two medical procedures associated to the report section a procedure output;
displaying the retrieved section identifier, the retrieved at least two medical procedure identifiers, and the retrieved at least two procedure outputs.

10. The method of claim 1, further comprising:
providing a list of a plurality reporting tasks, each reporting task corresponding to one non-reported medical procedure;
in response to defining the first medical procedure and second medical as to-be-reported, removing a first of the reporting tasks corresponding to the first medical procedure from the list and removing a second of the reporting tasks corresponding to the second medical procedure from the list.

11. The method of claim 1, further comprising:
receiving a user entry for the at least one report section being associated to the first medical procedure and the second procedure;
associating the user entry with the first medical procedure and the second medical procedure.

12. A system for reporting a plurality of medical procedures, the system comprising:
a memory for storing a plurality of instructions;
a data storage device; and
a processor coupled to the memory, the processor configured for:
defining a first medical procedure and second medical procedure as to-be-reported;
creating a plurality of report sections for the first medical procedure and the second medical procedure;
associating a first subset of the created report sections with the first medical procedure;
associating a second subset of the created report sections with the second medical procedure, at least one report section of the second subset also be associated with the first medical procedure;
receiving a request for undefining the first medical procedure as to-be-reported; and
in response to the request for undefining the first medical procedure, disassociating the first medical procedure from each of the at least one report section that is associated with the first medical procedure and the second medical procedure.

13. The system of claim 12, the processor being further configured for:
in response to the request for undefining the first medical procedure, deleting at least one report section being uniquely associated with the first medical procedure.

14. The system of claim 12, the processor being further configured for:
selecting a first report structure for the first procedure, the first report structure defining the first subset of report sections;
selecting a second report structure for the second procedure, the second report structure defining the second subset of report sections;
wherein the plurality of created report sections is defined by a union of the first subset and the second subset.

15. The system of claim 14, the processor being further configured for:
for at least one report section belonging to an intersection of the first subset and the second subset, the report section is created only once.

16. The system of claim 12, wherein if the first and second medical procedures belong to the same medical order, automatically defining the first medical procedure and the second medical procedure as to-be-reported.

17. The system of claim 12, the processor being further configured for:
for at least a first report section associated to a plurality of medical procedures defined as to-be-reported:
retrieving an identifier of the report section;
for each of at least two medical procedures associated to the report section, retrieving at least one procedure output; and
displaying the retrieved section identifier and the at least one retrieved procedure output.

18. The system of claim 17, the processor being further configured for:
storing the retrieved section identifier, the retrieved medical procedure identifier, and the retrieved at least one procedure output as a stored report section.

19. The system of claim 18, the processor being further configured for:
for at least a second report section associated to a plurality of medical procedures defined as to-be-reported:
retrieving an identifier of the second report section;
for each of at least two medical procedures associated to the second report section, retrieving at least one procedure output; and
displaying the retrieved section identifier and the retrieved procedure outputs;
storing the retrieved section, the retrieved medical procedure identifier, and the retrieved at least one procedure output as a stored report section; and
if the first report section and the second report section are associated with the same medical procedure, storing the first stored report section and the second stored report section within the same medical record.

20. The system of claim 12, the processor being further configured for:
defining a third medical procedure as to-be-reported;
associating a third subset of the created report sections with the third medical procedure, at least one report section of the third subset also being associated with the second medical procedure;
for at least one report section associated to a plurality of medical procedures defined at to-be-reported:
retrieving an identifier of the report section;
retrieving for each of at least two medical procedures associated to the report section a procedure output;
displaying the retrieved section identifier, the retrieved at least two medical procedure identifiers, and the retrieved at least two procedure outputs.

21. The system of claim 12, the processor being further configured for:
providing a list of one or more reporting tasks, each reporting task corresponding to one non-reported medical procedure;
in response to defining the first medical procedure and second medical procedure as to-be-reported, removing a first of the reporting tasks corresponding to the first medical procedure from the list and removing a second of the reporting tasks corresponding to the second medical procedure from the list.

22. The system of claim 1, the processor being further configured for:
receiving a user entry for the at least one report section being associated to the first medical procedure and the second procedure;
associating the user entry with the first medical procedure and the second medical procedure.

23. A physical non-transient computer-readable medium upon which a plurality of instructions are stored, the instructions for performing the steps of the method as claimed in claim 1.
